(19) United States
(12) Patent Application Publication
(10) Pub. No.: US 2026/0128962 A1
(43) Pub. Date: May 7, 2026

(54) COMMUNICATION METHOD AND COMMUNICATION APPARATUS

(71) Applicant: Huawei Technologies Co., Ltd., Shenzhen (CN)

(72) Inventors: Yiqun Ge, Ottawa (CA); Hao Tang, Ottawa (CA); Jianglei Ma, Ottawa (CA)

(21) Appl. No.: 19/416,571

(22) Filed: Dec. 11, 2025

Related U.S. Application Data
(63) Continuation of application No. PCT/CN2023/125044, filed on Oct. 17, 2023.
(60) Provisional application No. 63/507,872, filed on Jun. 13, 2023.

(51) Int. Cl. H04L 41/16; H04L 25/03

(52) U.S. Cl. CPC H04L 41/16; H04L 25/0391

(57) ABSTRACT

Embodiments of the present application provide a communication method and a communication apparatus. The communication method includes: obtaining Q group(s) of first data sample(s) corresponding to Q layer(s) of an AI model, where the Q group(s) of the first data sample(s) is from compressed Q group(s) of first raw data sample(s) which is compressed according to Q transformation matrix(es), the Q group(s) of the first data sample(s) is related to an inference cycle of the AI model, and Q is a positive integer; and sending the Q group(s) of the first data sample(s).

### CROSS-REFERENCE TO RELATED APPLICATIONS

The present application is a continuation of International Application No. PCT/CN2023/125044, filed on Oct. 17, 2023, which claims priority to U.S. Provisional Patent Application No. 63/507,872, filed on Jun. 13, 2023.

The disclosures of the aforementioned applications are hereby incorporated by reference in their entirety.

### TECHNICAL FIELD

Embodiments of the present application relate to the field of communications, and more specifically, to a communication method and a communication apparatus.

### BACKGROUND

Artificial intelligence (AI)-based algorithms have been introduced into wireless communications to solve some wireless problems such as channel estimation, scheduling, channel state information (CSI) compression, positioning, beam-management, and so on. AI algorithm is a data-driven method that tunes some pre-defined architectures by a set of data samples called as training data set.

During the inference cycle of the AI model, data needs to be transmitted. Raw data may include user privacy. It may be against the privacy policy to transmit raw data. In addition, transmitting raw data may consume a lot of resources and is inefficient.

Therefore, an urgent technical problem that needs to be solved is how to improve data transmission efficiency.

### SUMMARY

Embodiments of the present application provide a communication method and a communication apparatus. The technical solutions may improve data transmission efficiency.

According to a first aspect, an embodiment of the present application provides a communication method, including obtaining Q group(s) of first data sample(s) corresponding to Q layer(s) of an AI model, where the Q group(s) of the first data sample(s) is from compressed Q group(s) of first raw data sample(s) which is compressed according to Q transformation matrix(es), the Q group(s) of the first data sample(s) is related to an inference cycle of the AI model, and Q is a positive integer; and sending the Q group(s) of the first data sample(s).

According to the above technical solution, the first data sample is a low-dimensional data sample which is compressed according to a transformation matrix. In this way, the bandwidth for the first data sample(s) can be saved and data transmission efficiency can be improved. At the same time, first raw data can be protected.

Each group may correspond to one layer of the AI model. Different groups may correspond to different layers.

In a possible design, the method further includes: sending first information indicating the Q transformation matrix(es).

Optionally, a transformation matrix be a unitary matrix or an orthonormal matrix.

Optionally, each basis vector of a transformation matrix may be a standard basis such as Fourier basis, DCT basis, wavelet basis, or the like.

In a possible design, the first information is further configured to indicate Q sampling matrix(es), the Q sampling matrix(es) is configured to sample Q group(s) of second raw data sample(s), and the Q transformation matrix(es) is configured to compress sampling result(s) of the Q group(s) of the second raw data sample(s) into Q group(s) of second data sample(s).

Optionally, a sampling matrix may be a random matrix or a pseudo-random matrix.

According to the above technical solution, the data sample can be obtained by compressing the raw data sample according to the sampling matrix and the transformation matrix. The dimensions of the sampling matrix and transformation matrix are smaller, which is beneficial to reducing the resources required for transmitting the sampling matrix and transformation matrix, thereby improving transmission efficiency.

In a possible design, the method further includes: receiving second information indicating difference(s) between q group(s) of second data sample(s) and q group(s) of the first data sample(s) in the Q group(s) of the first data sample(s), where the q group(s) of the second data sample(s) is based on inputs or outputs of q layer(s) in the Q layer(s) during the inference cycle, and q is a positive integer, q≤Q.

For a first data sample and a second data sample corresponding to the same layer, the distance between the first data sample and the second data sample is approximately the same as the distance between the first raw data sample and the second raw data sample. In this way, computational complexity can be reduced, which is beneficial to improving processing efficiency.

In a possible design, the difference(s) between the q group(s) of the second data sample(s) and the q group(s) of the first data sample(s) is configured to check whether the inference cycle is abnormal.

For example, if the distances corresponding to all the groups are consistently below the corresponding threshold(s), the current inference cycle may be considered normal.

According to the above technical solution, the difference(s) can be used to check whether the current inference cycle works as expected, which is conducive to ensuring the communication quality.

In addition, the inference cycle detection can be implemented with lower dimensional space. Compared to calculating the distance(s) between the first raw data sample(s) and the second raw data sample(s) in the original dimension, the dimensions of the first data sample(s) and second data sample(s) are lower, so the computational complexity can be reduced which is beneficial to improving processing efficiency.

In a possible design, the method further includes: sending third information indicating correspondence between the Q layer(s) and the Q group(s) of the first data sample(s).

In a possible design, the method further includes: sending fourth information indicating Q scoring function(s), where the Q scoring function(s) is configured to measure difference(s) between the Q group(s) of the first data sample(s) and Q group(s) of second data sample(s), and the Q group(s) of second data sample(s) is based on the inputs or outputs of the Q layer(s).

Optionally, each scoring function may be used to measure the distance between two samples.

Optionally, each scoring function may be used to measure the distance between two distributions.

According to a second aspect, an embodiment of the present application provides a communication method, including: receiving Q group(s) of first data sample(s) corresponding to Q layer(s) of an AI model, where the Q group(s) of the first data sample(s) is from compressed Q group(s) of first raw data sample(s) which is compressed according to Q transformation matrix(es), the Q group(s) of the first data sample(s) is related to an inference cycle of the AI model, and Q is a positive integer.

In a possible design, the method further includes: receiving first information indicating the Q transformation matrix(es).

In a possible design, the first information is further configured to indicate Q sampling matrix(es), the Q sampling matrix(es) is configured to sample Q group(s) of second raw data sample(s), and the Q transformation matrix(es) is configured to compress sampling result(s) of the Q group(s) of the second raw data sample(s) into Q group(s) of second data sample(s).

In a possible design, the method further includes: sending second information indicating difference(s) between q group(s) of second data sample(s) and q group(s) of the first data sample(s) in the Q group(s) of the first data sample(s), where the q group(s) of the second data sample(s) is based on inputs or outputs of q layer(s) in the Q layer(s) during the inference cycle, and q is a positive integer, q≤Q.

In a possible design, the difference(s) between the q group(s) of the second data sample(s) and the q group(s) of the first data sample(s) is configured to determine whether the inference cycle of the AI model is abnormal.

In a possible design, the method further includes: receiving third information indicating correspondence between the Q layer(s) and the Q group(s) of the first data sample(s).

In a possible design, the method further includes: receiving fourth information indicating Q scoring function(s), where the Q scoring function(s) is configured to measure difference(s) between the Q group(s) of the first data sample(s) and Q group(s) of second data sample(s), and the Q group(s) of the second data sample(s) is based on inputs or outputs of the Q layer(s).

According to a third aspect, a communication apparatus is provided. The communication apparatus includes a function or unit configured to perform the method according to the first aspect or any one of the possible designs of the first aspect.

For example, the communication apparatus may be a network device or a chip in the network device. For another example, the communication apparatus may be a terminal device or a chip in the terminal device.

According to a fourth aspect, a communication apparatus is provided. The communication apparatus includes a function or unit configured to perform the method according to the second aspect or any one of the possible designs of the second aspect.

For example, the communication apparatus may be a terminal device or a chip in the terminal device. For another example, the communication apparatus may be a network device or a chip in the network device.

According to a fifth aspect, a system is provided. The system includes: the communication apparatus according to the third aspect and the communication apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible designs of the first aspect, or the communication apparatus performs the method in any one of the second aspect or the possible designs of the second aspect.

For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible designs of the first aspect, or the second aspect or any one of the possible designs of the second aspect.

According to an eighth aspect, a computer storage medium is provided. The computer storage medium stores program code, and the program code is used to execute one or more instructions for the method according to the first aspect or any one of the possible designs of the first aspect, or the second aspect or any one of the possible designs of the second aspect.

According to a ninth aspect, the present application provides a computer program product including one or more instructions, where when the computer program product runs on a computer, the computer performs the method according to the first aspect or any one of the possible designs of the first aspect, or the second aspect or any one of the possible designs of the second aspect.

### DESCRIPTION OF DRAWINGS

FIG. 1 is a schematic diagram of an application scenario according to the present application;

FIG. 2 illustrates an example communication system 100;

FIG. 3 illustrates an example device in the communication system;

FIG. 4 is a schematic diagram of a device in two cycles according to an embodiment of the present application;

FIG. 5 illustrates example local data of a device according to an embodiment of the present application;

FIG. 6 is a schematic diagram of the working situation of an AI model;

FIG. 7 is a schematic diagram of an example scenario;

FIG. 8 illustrates an example data transmission between two devices according to an embodiment of the present application;

FIG. 9 is a schematic diagram of three groups of reference data sample(s) according to an embodiment of the present application;

FIG. 10 is a schematic diagram of an example distance calculation according to an embodiment of the present application;

FIG. 11 is schematic diagram of two examples of encoders according to an embodiment of the present application;

FIG. 12 is a schematic flowchart of a communication method according to an embodiment of the present application;

FIG. 13 is a schematic diagram of an example compression process of a reference data sample according to an embodiment of the present application;

FIG. 14 is a schematic diagram of an example X according to an embodiment of the present application;

FIG. 15 is a schematic diagram of an example compression process according to an embodiment of the present application;

FIG. 16 is a schematic diagram of an example distance on the low spectrum space according to an embodiment of the present application;

FIG. 17 is a schematic diagram of the autoencoder with one group of reference data samples according to an embodiment of the present application;

FIG. 18 is a schematic diagram of three groups of reference data samples according to an embodiment of the present application; and

FIGS. 19-23 are schematic block diagrams of possible devices according to embodiments of the present application.

### DESCRIPTION OF EMBODIMENTS

The following describes technical solutions of the present application with reference to the accompanying drawings.

The embodiments of the present invention may be applied to communication systems of next generation (e.g., sixth generation (6G) or later), 5th Generation (5G), new radio (NR), long term evolution (LTE), or the like.

FIG. 1 is a schematic structural diagram of an example communication system.

Referring to FIG. 1, as an illustrative example without limitation, a simplified schematic illustration of a communication system is provided. A communication system 100 includes a radio access network 120. The radio access network 120 may be a next generation (e.g., 6G or later) radio access network, or a legacy (e.g., 5G, 4G, 3G or 2G) radio access network. One or more communication electronic device (ED) 110a-120j (generically referred to as 11o) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

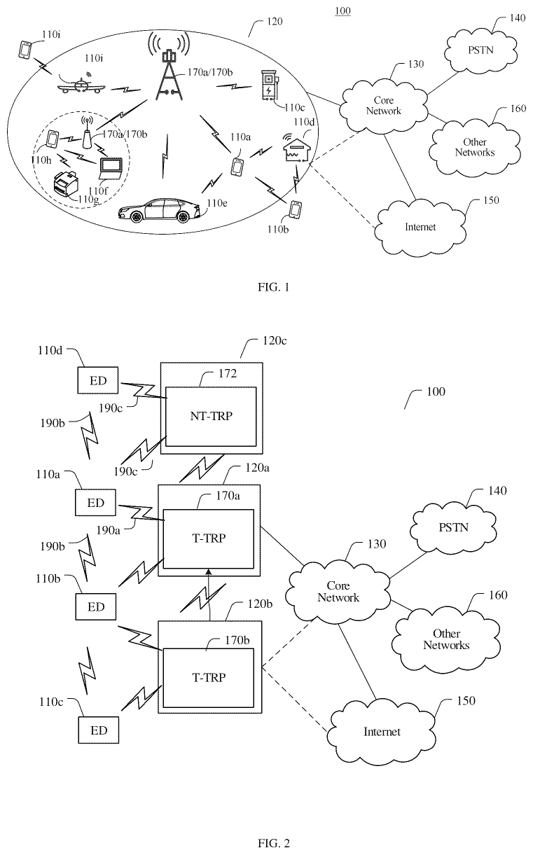

FIG. 2 is a schematic structural diagram of another example communication system.

In general, a communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet protocol (IP), transmission control protocol (TCP), and user datagram protocol (UDP). EDs 110a 110b, and 110c may be multimode devices capable of operation according to multiple radio access technologies, and incorporate multiple transceivers necessary to support such.

The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a personal communications service (PCS) phone, a session initiation protocol phone, a wireless local loop (WLL) station, a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the foregoing devices, among other possibilities. Future generation EDs 11o may be referred to using other terms. The base station 170a and 170b is a T-TRP and will hereafter be referred to as T-TRP 170. A NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay nodes, donor nodes, or the like, or combinations thereof. The T-TRP 170 may refer to the foregoing devices or apparatus (e.g., communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The NT-TRP 172 may be known by other names in some implementations, such as a non-terrestrial node, a non-terrestrial network device, or a non-terrestrial base station.

Artificial intelligence (AI) technologies can be applied in communication, including artificial intelligence or machine learning (AI/ML) based communication in the physical layer and/or AI/ML based communication in the higher layer, such as medium access control (MAC) layer. For example, in the physical layer, the AI/ML based communication may aim to optimize component design and/or improve the algorithm performance. For example, AI/ML may be applied in relation to the implementation of channel coding, channel modelling, channel estimation, channel decoding, modulation, demodulation, multiple-input multiple-output (MIMO), waveform, multiple access, physical layer element parameter optimization and update, beam forming, tracking, sensing, and/or positioning, etc. For the MAC layer, the AI/ML based communication may aim to utilize the AI/ML capability for learning, prediction, and/or making decisions to solve a complicated optimization problem with possible better strategy and/or optimal solution, e.g., to optimize the functionality in the MAC layer. For example, AI/ML may be applied to implement: intelligent transmission and reception point (TRP) management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

In order to facilitate understanding of the embodiments of the present application, terms related to AI/ML that may be involved in the embodiments of the present application are described below.

### (1) Data Collection

Data is a very important component for AI/ML techniques. Data collection is a process of collecting data by the network nodes, management entity, or UE for the purpose of AI/ML model training, data analytics, and inference.

### (2) AI/ML Model Training

AI/ML model training is a process to train an AI/ML Model by learning the input/output relationship in a data driven manner and obtain the trained AI/ML Model for inference.

### (3) AI/ML Model Inference

A process of using a trained AI/ML model to produce a set of outputs based on a set of inputs.

### (4) AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### (5) AI/ML Model Testing

Similar to validation, testing is also a sub-process of training, and it is used to evaluate the performance of a final AI/ML model using a dataset different from the one used for model training and validation. Different from AI/ML model validation, testing does not assume subsequent tuning of the model.

### (6) Online Training

Online training means an AI/ML training process where the model being used for inference is typically continuously trained in (near) real-time with the arrival of new training samples.

### (7) Offline Training

Offline training is an AI/ML training process where the model is trained based on the collected dataset, and where the trained model is later used or delivered for inference.

### (8) AI/ML Model Delivery/Transfer

AI/ML model delivery/transfer is a generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### (9) Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for the sustainable operation of AI/ML in the NR air-interface.

Life cycle management covers the whole procedure of AI/ML technologies applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicators (KPIs), and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to environmental changes, and thus the model based on input or output data distribution should also be considered.

### (10) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

### (11) Federated Learning (FL)

Federated learning is a machine learning technique that is used to train an AI/ML model by a central node (e.g., server) and a plurality of decentralized edge nodes (e.g., UEs, next Generation NodeBs, “gNBs”). The central node can also be called the central device. The edge nodes can also be called worker or worker devices. The central device is connected to the worker devices.

According to the wireless FL technique, a central node may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the central node, a set of AI/ML model parameters that describe the local AI/ML model.

Upon receiving, from a plurality of edge nodes, a plurality of sets of AI/ML model parameters that describe respective local AI/ML models at the plurality of edge nodes, the central node may aggregate the local AI/ML model parameters reported from the plurality of edge nodes and, based on such aggregation, update the global AI/ML model. A subsequent iteration progresses much like the first iteration. The central node may transmit the aggregated global model to a plurality of edge nodes. The above procedure is performed multiple iterations until the global AI/ML model is considered to be finalized, for example, the AI/ML model is converged or the training stopping conditions are satisfied.

The wireless FL technique does not involve the exchange of local data samples. Indeed, the local data samples remain at respective edge nodes.

AI-based algorithms have been introduced into wireless communications to solve a number of wireless problems such as channel estimation, scheduling, CSI compression (from UE to BS), beamforming for MIMO, localization, and so on. AI algorithms are a data-driven approach to tuning some predefined architectures by a set of data samples called training data sets.

Neural networks are a typical way to implement AI algorithms. Deep neural network (DNN) is taken as an example, the DNN can be trained with the training data sets to obtain a model for inference. Recent AI trains DNN architectures by setting up neurons with stochastic gradient descent (SGD) algorithms. For example, DNN includes CNN, RNN, transformers, and the like.

A communication system includes a plurality of connected devices. For example, a device may be a BS or UE. For example, the communication system may be the communication system 100 in FIG. 1 or FIG. 2, and the devices can be the network elements shown in FIG. 1 or FIG. 2.

FIG. 3 is a schematic structural diagram of a device according to an embodiment of the present application. As shown in FIG. 3, the device may include at least one of sensing module, communication module, or AI module. The sensing module may be configured to sense and collect signals and/or data. The communication module may be configured to transmit and receive signals and/or data. The AI module may be configured to train and/or reason the AI implementations.

In order to facilitate understanding of the embodiment of the present application, DNN is taken as an example to illustrate an AI implementation in an embodiment of the present application.

An exemplary AI implementation is DNN-based in two cycles: a training cycle and an inference cycle. The training cycle may also be called the learning cycle. The inference cycle may also be called the reasoning circle.

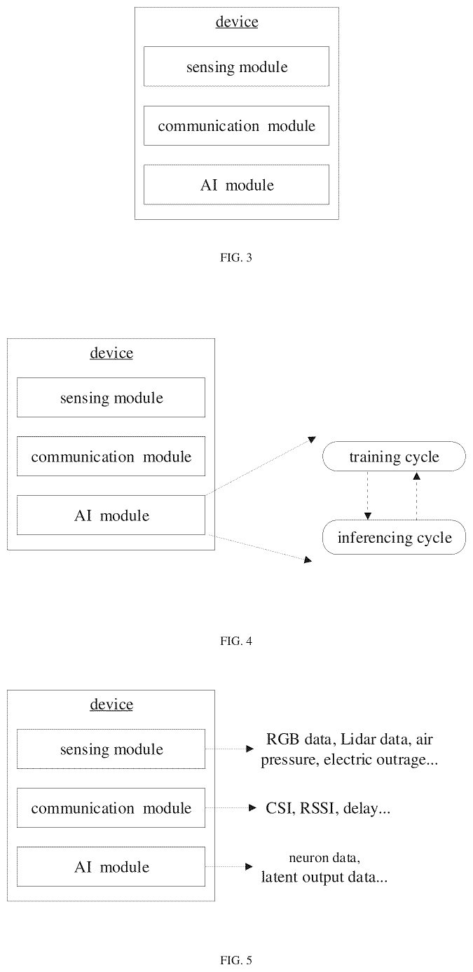

FIG. 4 is a schematic diagram of a device in two cycles according to an embodiment of the present application.

As an example, during an inference cycle, the AI module of the device may perform one inference or a series of inferences with one or more DNNs to fulfill one or more tasks, where the sensing module of the device may generate signals and/or data and the communication module of the device may receive the signals and/or data from other device or devices. For example, the inputs of the one or more DNNs may be the signals and/or data generated by the sensing module of the device, and/or the signals and/or data received by the communication module of the device. After the AI module of the device finishes inferencing, the communication module of the device may transmit the inferencing results to other device or devices.

As another example, during a training cycle, the AI module of the device may train one or more DNNs, where the sensing module of the device may generate signals and/or data and the communication module of the device may receive the signals and/or data from other device or devices. For example, the training data of the one or more DNNs may be the signals and/or data generated by the sensing module of the device, and/or the signals and/or data received by the communication module of the device. During and/or after the AI module finishes training, the communication module of the device may transmit the training results to other device or devices.

The AI implementations may either switch between the two cycles or stay in the two cycles simultaneously.

For example, the AI module of the device may train a DNN during the training cycle. And at the end of the training cycle, the AI implementation switches to the inference cycle, which means the AI module performs inference on that trained DNN. At the end of the inference cycle the AI implementation switches to the training cycle again, and so on.

For another example, the AI module of the device may train a second DNN but still perform inference on a first DNN.

The device mentioned above is merely an example, and the way in which the modules are divided and the number of modules in FIG. 3 and FIG. 4 do not constitute any limitation to the embodiments of the present application. For example, a communication module may be replaced by two modules, i.e., a transmitting module and a receiving module. The transmitting module may be configured to transmit signals and/or data, and the receiving module may be configured to receive signals and/or data. For another example, the sensing module and the communication module may be integrated as one module. For another example, the device may also include a processing module. The processing module may be configured to process signals and/or data. For another example, the device may not include the AI module. For another example, the AI module may only be configured to reason the AI implementation, or the AI module only stays in the inference cycle.

Wireless systems may support AI in both learning and inferencing cycles for generalization and interconnections.

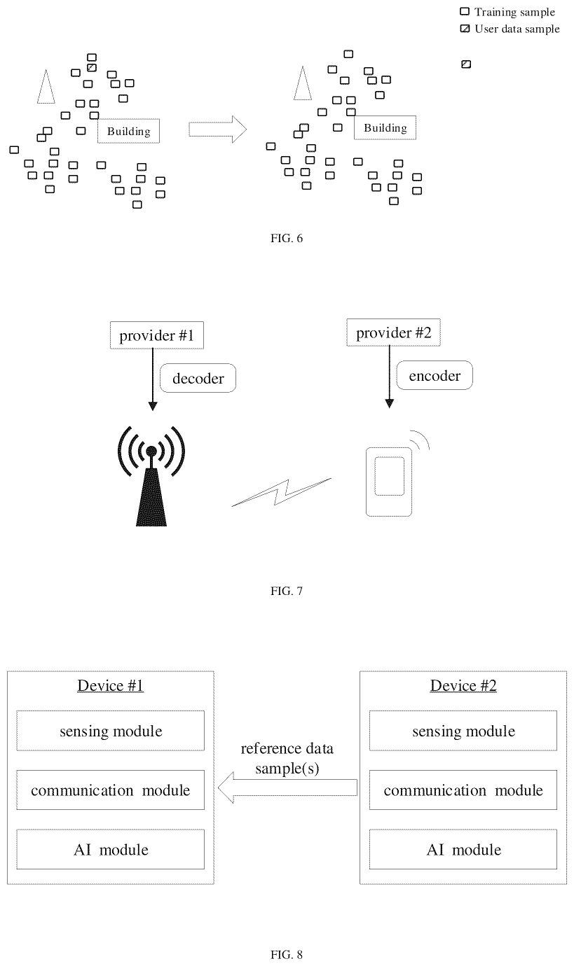

FIG. 5 shows example local data of a device. The local data of a device may include at least one of the following: local sensing data provided by the sensing module of the device, local channel data provided by the communication module of the device, local AI model data provided by the AI module of the device, or local latent output data provided by the AI module of the device. The local channel data is based on the measurement results of the channel. The local channel data can also be considered as sensing results. Thus, the local channel data can be considered as provided by the communication modules or sensing module.

For example, as shown in FIG. 5, the local sensing data may include at least one of RGB data, Lidar data, temperature, air pressure, or electric outage.

For example, as shown in FIG. 5, the local channel data may include at least one of channel state information (CSI), received signal strength indication (RSSI), or delay.

The local AI model data can also be referred to as neuron data. For example, as shown in FIG. 5, the local AI model data may include at least one of the following: part or all of the neurons in the local AI model(s) deployed on the device or part or all of gradients of the local AI model(s) deployed on the device. Neurons can be considered as functions including weights.

For example, as shown in FIG. 5, the local latent output data may include one or more latent outputs of the local AI model(s) deployed on the device.

A device may receive the local data of one or more other devices. As an example, the data received by the communication module of the device may include at least one of sensing data of one or more other devices, channel data of one or more other devices, AI model data of one or more other devices, or latent output data of one or more other devices.

For example, the data received by the communication module of device #A may include channel data of device #B and device #C, and AI model data of device #C. The channel data of device #B and device #C refer to the local channel data of device #B and the local channel data of device #C. The AI model data of device #C refers to the local AI model data of device #C. Device #A, device #B, and device #C are different devices.

For example, sensing data received by the communication module may include at least one of RGB data, Lidar data, temperature, air pressure, or electric outage.

For example, channel data received by the communication module may include at least one of CSI, RSSI, or delay.

For example, AI model data received by the communication module may include at least one of part or all of the neurons in the AI model(s), or part or all of gradients of the AI model(s).

For example, latent output data received by the communication module may include one or more latent outputs of the AI model(s).

Whether the AI model deployed on a device can work is crucial for communication quality.

As a data-driven method, an AI model inevitably suffers from low generalization. If a real-world sample, such as a user data sample, is outlier to the training data set, the AI model wouldn't make a good inference on the real-world sample. Moreover, even given an outlier input, the AI model may not detect it.

For example, in wireless communication, the user device is moving. The AI model deployed on the user device may work in some environments, but may not work in others, which can affect the communication quality.

FIG. 6 is a schematic diagram of the working situation of an AI model.

As shown in FIG. 6, when the user data sample collected by the user device is within the zone of the training samples used to train the AI model, the AI model can work. As the user device moves, the user data sample collected by the user device may be outside the zone of the training samples, and the AI model doesn't work.

In wireless communication, AI models deployed on different devices may need to work together. Dual sided model is taken as an example. Dual sided model may be in a form of AE, whose encoding DNN is on transmitter side and decoding DNN on receiver side. The encoding DNN and decoding DNN are likely trained and provided by different providers. Moreover, it is hard for AI providers to open their DNN models. This may result in the AI models not working together.

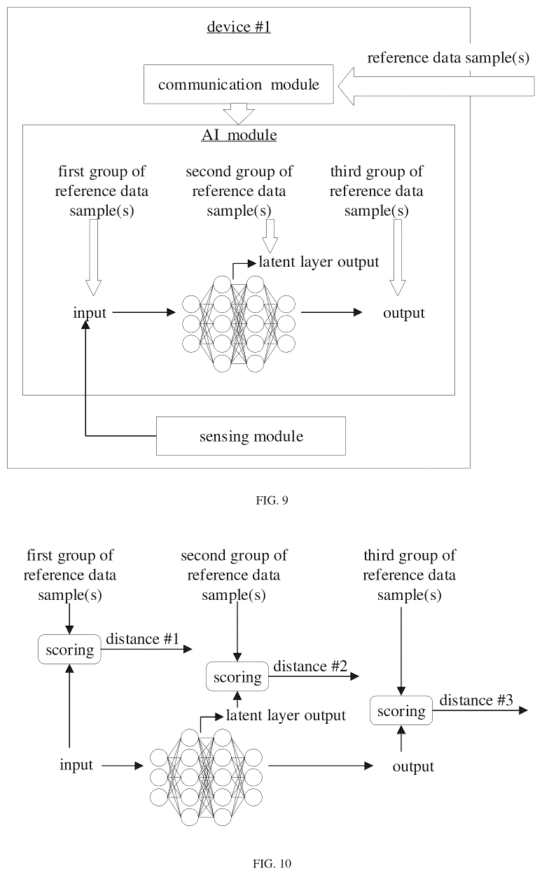

FIG. 7 is a schematic diagram of an example scenario.

As shown in FIG. 7, an encoder deployed on UE and a decoder deployed on BS need to work together. However, the encoder and the decoder may be trained independently by different providers, e.g., provider #1 and provider #2 in FIG. 7, which may affect their interconnection.

The embodiment of the present application provides a communication method that ensures that the AI model can work through the comparison between reference data and local data, thereby improving the communication performance. The reference data can also refer to a reference signal. The local data can also refer to a local signal. For the convenience of description, no distinction will be made in the embodiments of the present application.

During the inference cycle, the AI module of a device may work in a single user mode or cooperative mode. In both modes, the device may receive reference data sample(s) from one or more other devices. Or the reference data sample(s) may be pre-stored on the device.

The type of the local data sample(s) may be related to any type of the data mentioned in FIG. 5. For example, the local data sample(s) may be corresponding to Lidar data. For another example, the local data sample(s) may be corresponding to CSI.

The local data sample(s) generated by one device can be transmitted to another device as reference data sample(s) for the AI model on another device.

For example, device #1 may receive reference data sample(s) from device #2. The local data sample(s) generated by the device #2 can be regarded as the reference data sample(s) for the AI model on device #1.

The reference data sample(s) may be related to any type of the data received by the communication module of the device mentioned above. For example, the reference data sample(s) may be corresponding to Lidar data. For another example, the reference data sample(s) may be corresponding to CSI.

In the case of receiving a plurality of groups of reference data sample(s), the type of the data may be the same.

FIG. 8 shows an example of the data transmission between two devices.

Specifically, a device may receive Q group(s) of reference data sample(s) from another device. Q is a positive integer.

In the case of receiving a plurality of groups of reference data sample(s), the number of reference data samples in each group can be the same or different.

For example, other device(s) may transmit Q group(s) of reference data sample(s) in broadcast, multicast, or unicast channels.

The Q group(s) of reference data sample(s) corresponds to Q group(s) of local data sample(s), respectively. The distance between each group in the Q group(s) of reference data sample(s) and the corresponding group in the Q group(s) of local data sample(s) may be measured.

The Q group(s) of reference data sample(s) may correspond to Q layer(s) of AI model(s), respectively. One group of reference data sample(s) corresponds to one layer, which may be understood as the group of reference data sample(s) corresponds to the inputs or outputs of the layer. Correspondingly, the Q group(s) of local data sample(s) may be based on the Q layer(s) of AI model(s). For each group of the reference data samples(s), the corresponding group of local data sample(s) is based on the layer corresponding to the group of the reference data sample(s). The local data sample(s) may be sampled from the local data related to the layer(s). The local data may be the inputs or outputs of the Q layer(s). The Q group(s) of local data sample(s) may be sampled from the inputs or outputs of the Q layer(s). For example, one group of reference data sample(s) corresponds to the inputs of an AI model, in which case, the corresponding group of local data sample(s) may be obtained by sampling the inputs of the AI model.

As an example, the AI module of the device may randomly, non-randomly, uniformly, or non-uniformly sample its local data related to the Q layer(s) to obtain the Q group(s) of local data sample(s).

The Q group(s) of reference data sample(s) may be related to Q layer(s) of one or more AI models. For the convenience of description, in the embodiments of present application, only the Q layers belonging to one AI model are used as an example for explanation.

FIG. 9 is a schematic diagram of three groups of reference data sample(s).

For example, as shown in FIG. 9, there are three groups of reference data sample(s) received by the communication module of the device #1. The three groups of reference data sample(s) may be processed by the AI module of the device #1. The first group corresponds to the input layer of an AI model, the second group corresponds to one latent layer of the AI model, and the third group corresponds to the output layer of the AI model. Specifically, the first group corresponds to the inputs of the AI model, the second group corresponds to one latent layer outputs of the AI model, and the third group corresponds to the outputs of the AI model. The AI model may be a local AI model of the device #1. The first group of local data sample(s) may be sampled from the inputs to the AI model, the second group of local data sample(s) may be sampled from the latent layer outputs and the third group of local data sample(s) may be sampled from the outputs from the AI model. For example, as shown in FIG. 9, the inputs of the AI model may include the local sensing data provided by the sensing module of the device #1.

FIG. 9 is merely an example and shall not constitute any limitation on the present application. For example, the inputs of the AI model may also include data from other sources, such as data received by the communication module of the device #1. For another example, the inputs of the AI model may include the data that has been preprocessed for the local sensing data provided by the sensing module of the device #1. For another example, the number of groups of reference data sample(s) may be other values. The three groups of reference data sample(s) may be related to other layers.

The reference data sample(s) may be used to determine whether the current inference procedure is abnormal or not. In other words, the reference data sample(s) may be used to determine whether the current inference procedure is working as expected.

The following describes examples of application scenarios for the reference data sample(s).

If the AI model does not work during the inference cycle of as expected, it may be damaged, it may not be suitable for the current data, for example, the AI model may be outdated, or it may not be able to work with other AI models. The abnormal inference cycle of the AI model may lead to incorrect inference results, which may affect the relevant data processing results or data transmission quality.

The distance(s) between the local data sample(s) and the reference data sample(s) can be used to check whether the current inference cycle works as expected, which is conducive to ensuring the communication quality.

In some scenarios, as the device moves, the local data collected by the device may be outside the zone of the training samples, statistically outliers, and the AI model deployed on the device doesn't work.

The distance(s) between the local data sample(s) and the reference data sample(s) can be used to check whether the AI model can work. In other words, the distance(s) between the local data sample(s) and the reference data sample(s) can be used to check generalization of the AI model.

As an example, the reference data sample(s) may be related to the training data of the AI model.

Exemplarily, AI model #A can be a trained model. The reference data sample(s) may be generated when the AI model #A performs inference on target data. The target data is within the training data range, so the likelihood of the AI model #A's inference process working properly is higher. Based on the inputs, outputs, and/or latent layer outputs of the AI model during this inference process, the reference data sample(s) can be generated. The closer the local data sample(s) of an AI model is to the reference data sample(s), the greater the likelihood that the AI model can work.

Reference data sample(s) can also be determined through other methods. The embodiments of the present application do not limit this.

In the embodiments of the present application, the distance between the reference distribution and the distribution of the latent layer can be used to check whether AI model can work with the current local data, which is conducive to ensuring the quality of data processing or communication.

In some scenarios, a plurality of AI models need to work together. For example, the output of a latent layer of one AI model may be the input of a latent layer of another AI model. These AI models may be trained independently by different providers.

The distance(s) between the local data sample(s) and the reference data sample(s) can be used to check whether a plurality of AI models that need to work together can work together. In other words, the distance(s) between the local data sample(s) and the reference data sample(s) can be used to check the interconnection or cross consistency of the AI models.

The closer the local data sample(s) of an AI model is to the local data sample(s) of another AI model, the greater the likelihood that the two AI models can work together.

For example, for two AI models with the same structure (such as AE #A and AE #B), the smaller the distance between the local data sample(s) corresponding to the output of the encoder of the AE #A and the local data sample(s) corresponding to the output of the encoder of the AE #A, the higher the possibility that the two AI models can work together, that is, the output of the encoder of the AE #A can be used as the input of the decoder of AE #B, or, the output of the encoder of the AE #B can be used as the input of the decoder of AE #A.

In some embodiments, for two AI models that need to work together, the reference data sample(s) may be sampled from the outputs of latent layer in one of the AI models. The distance between the reference data sample(s) and the local data sample(s) corresponding to the latent layer of another AI model can be used to check interconnection.

For example, for two AI models with the same structure (such as AE #A and AE #B), the reference data sample(s) may be sampled from the output of the encoder of AE #A, and the local data sample(s) may be sampled from the output of the encoder of AE #B. In this case, the smaller the distance between the reference data sample(s) and the local data sample(s), the greater the likelihood that the two AI models can work together.

Reference data sample(s) can also be determined through other methods. The embodiments of the present application do not limit this.

In the embodiments of the present application, the distance between the reference distribution and the distribution of the latent layer can be used to check whether AI models can work together, which is conducive to ensuring the quality of data processing or communication.

The Q layer(s) may belong to one or more local AI models deployed on the device. The embodiments of the present application do not limit the number of local AI models. For the convenience of description, the embodiments of the present application mainly use a local AI model as an example for explanation, and the implementation methods of other local AI models can refer to this local AI model.

Specifically, the distance(s) between the Q group(s) of reference data sample(s) and the corresponding group(s) of local data sample(s) may be used to determine whether the AI model works as expected.

Optionally, the device may measure the distance(s) between the local data sample(s) and the reference data sample(s) group by group to obtain Q distance(s) corresponding to the Q group(s). And then the Q distance(s) may be used to determine whether the AI model works as expected.

Alternatively, the device may measure the distance(s) between the local data sample(s) and the reference data sample(s) group by group to obtain q distance(s) corresponding to q group(s) in the Q group(s). In other words, the device may calculate distance based on a portion of the Q group(s). And then the q distance(s) may be used to determine whether the AI model works as expected.

The relationship between the distance(s) and the inference cycle can be set as needed.

For example, the greater the distance(s), the greater the likelihood of the inference cycle being abnormal. For the convenience of description, the embodiments of the present application will only be explained using this as an example.

The conditions for determining whether the AI model works as expected can be set as needed.

For example, if the distance(s) corresponding to all the group(s) is consistently below the corresponding threshold(s), the current inference procedure may be considered normal. Otherwise, the current inference procedure may be considered abnormal. In the case of a plurality of groups of reference data sample(s), the thresholds corresponding to different groups can be the same or different. The threshold(s) may be pre-defined. Or the threshold(s) may be received by the device. Or the threshold(s) may be determined by the device itself.

For another example, if the distance(s) corresponding to all the group(s) is consistently greater than or equal to the corresponding threshold(s), the current inference procedure may be considered abnormal. Otherwise, the current inference procedure may be considered normal. In the case of a plurality of groups of reference data sample(s), the thresholds corresponding to different groups can be the same or different. The threshold(s) may be pre-defined. Or the threshold(s) may be received by the device. Or the threshold(s) may be determined by the device itself.

For another example, in the case of a plurality of groups of reference data sample(s), if the average distance of all the groups is below a threshold, the current inference procedure may be considered normal. Otherwise, the current inference procedure may be considered abnormal. The threshold may be pre-defined. Or the threshold may be received by the device from the other device. Or the threshold may be determined by the device itself.

The above conditions are merely examples. Other conditions about the above distance can be set to determine whether the inference procedure works as expected.

FIG. 10 is a schematic diagram of an example distance calculation. The descriptions of the three groups of reference sample(s) can be referred to the descriptions related to FIG. 9, and will not be repeated here.

For example, as shown in FIG. 10, the AI module of device #1 may sample the inputs of the local AI model, the latent layer outputs, and the outputs of the local AI model to obtain three groups of local data sample(s), respectively. The three groups of local data sample(s) correspond to the three groups of reference data sample(s). Then the AI module of the device #1 measures the distances between the local data sample(s) and the reference data sample(s) group by group to obtain three distances corresponding to the three groups, namely distance #1, distance #2 and distance #3 in FIG. 10. If the average distances of these three groups are consistently below a threshold, the AI module of the device #1 may tell that the current inference procedure works as expected, otherwise the AI module may tell it is abnormal.

FIG. 10 is merely an example and shall not constitute any limitation on the present application.

Further, optionally, the device may also receive information indicating the Q layer(s).

For example, the information may be Q indicator(s) used to indicate the Q layer(s) related to the Q group(s) of reference data sample(s), respectively.

As an example, the Q indicator(s) may be the index(s) of the Q group(s) of reference data sample(s).

Alternatively, the Q layer(s) related to Q group(s) of reference data sample(s) may be predefined.

Further, optionally, the device may also receive information indicating the condition for determining whether the inference procedure is normal.

Alternatively, the condition may be predefined.

Alternatively, the condition may be determined by the device itself.

The distance(s) between the Q group(s) of reference data sample(s) and the Q group(s) of local data sample(s) may be measured through the corresponding Q scoring function(s).

In the case of a plurality of scoring functions, the Q scoring functions may be the same or different.

Further, optionally, the device may also receive the Q scoring function(s) from the other device.

Alternatively, the Q scoring function(s) may be predefined.

Alternatively, the Q scoring function(s) may be determined by the device itself.

Raw data may be considered as having user privacy. It may be against the privacy policy to transmit raw data. In addition, transmitting raw data may consume a lot of resources. It may be inefficient to transmit raw data.

The embodiment of the present application provides a communication method where raw data is compressed. Compression is to project high-dimensional data into a low-dimensional one by a transformation.

The raw data may include the reference data sample(s) mentioned above. For example, the reference data sample(s) may be compressed before being transmitted. Specifically, Q group(s) of the reference data sample(s) may be compressed to a lower dimensional space than the original dimensional space before being transmitted.

In this way, bandwidth for the reference data sample(s) can be saved and data transmission efficiency can be improved. At the same time, raw data that is the reference data sample(s), can be protected.

The raw data may include the local data sample(s) mentioned above. The distance(s) between the reference data sample(s) and the local data sample(s) may be replaced by compressed reference data sample(s) and compressed local data sample(s). The technical solution mentioned above can be done with lower dimensional space. For example, the inference cycle detection can be implemented with lower dimensional space. In this way, computational complexity can be reduced which is beneficial to improving processing efficiency. For example, it can be conducive to labeling data in real-time.

Raw data may be encoded or compressed to a lower dimensional space by a compressor. The encoder can also be called a compressor. The encoder can be linear or non-linear.

FIG. 11 is a schematic diagram of two examples of encoders.

For example, the encoder may be a linear encoder realized with some standard basis such as Fourier basis, discrete cosine transform (DCT) or wavelets; Or the encoder may be a linear encoder realized with some customized basis. For example, these bases may form a unitary matrix or an orthonormal matrix.

As shown in FIG. 11, the encoder and decoder are aligned on matrix U. Matrix U can be used as a codebook. For example, matrix U may be a unitary matrix. The encoder may encode the input x through U^{H} to obtain output c with a lower dimension. c may satisfy the following formula:

$$c = {U}^{H} x .$$

The decoder can decode c through U to obtain output z with the original dimension. \hat{x} may satisfy the following formula:

$$\hat{x} = Uc .$$

For another example, the encoder may be a non-linear encoder realized with an AI model, such as DNN. As shown in FIG. 11, the encoder and decoder may be realized with DNNs. The encoder may encode x to c, where c may satisfy the following formula:

$$c = F ( x ; α ) .$$

α represents the parameters of the encoder F( ).

The decoder may decode c to \hat{x}, where \hat{x} may satisfy the following formula:

$$\hat{x} = G ( c ; β ) .$$

β represents the parameters of the decoder G( ).

DNNs can be the approximation of matrix U.

Unlike the traditional compression schemes built for reliable reconstruction, the encoder in the embodiments of the present application may avoid a reliable reconstruction but preserve as much topological distances as possible, when the data is compressed into a lower dimensional space. That is to say, the relative distance between two data samples in their original dimensional space may be well preserved after being encoded into a low-dimensional space.

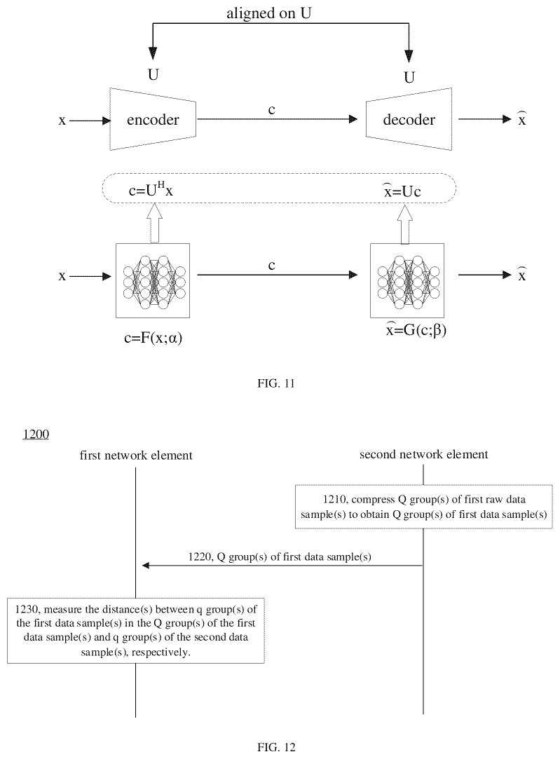

FIG. 12 is a schematic flowchart of a communication method provided by an embodiment of the present application.

As shown in FIG. 12, a method 1200 includes the following steps.

Step 1210, a second network element compresses Q group(s) of first raw data sample(s) to obtain Q group(s) of first data sample(s), where Q is a positive integer.

The Q group(s) of the first data sample(s) is from compressed Q group(s) of first raw data sample(s) which is compressed according to Q transformation matrix(es).

Step 1220, a first network element receives the Q group(s) of first data sample(s) from the second network element.

In step 1210, one first data sample is obtained by compressing the corresponding first raw data sample. In other words, the dimension of the first data sample is smaller than the dimension of the corresponding first raw data sample.

The reference data sample(s) mentioned above is an example of first data sample(s). The compressed reference data sample(s) mentioned above is an example of first raw data sample(s). Method 1200 will be illustrated using this as an example.

Method 1200 may be applied to an inference cycle of an AI model. Correspondingly, the first raw data sample(s) is related to the inference cycle of AI model(s).

Optionally, Q group(s) of compressed reference data sample(s) may correspond to Q layer(s) of AI model(s), respectively.

In other words, Q group(s) of reference data sample(s) may correspond to Q layer(s) of AI model(s), respectively.

Each group may correspond to one layer of AI model(s). Different groups may correspond to different layers.

As mentioned above, each group corresponds to output data or input data of one layer of AI model(s).

The Q layer(s) may belong to one or more AI models.

The specific description of the corresponding relationship can refer to the previous text, such as FIG. 9 or FIG. 10, and will not be repeated here.

For example, the second network element may be a network device or a terminal device. The second network element may be the device #2 mentioned above.

For example, the first network element may be a network device or a terminal device. The first network element may be the device #1 mentioned above.

According to the above technical solution, the first data sample is a low-dimensional data sample which is compressed according to a transformation matrix. In this way, the bandwidth for the first data sample(s) can be saved and data transmission efficiency can be improved. At the same time, first raw data can be protected.

The following describe two examples (example #1 and example #2) of compressing the reference data sample.

### Example #1

Optionally, in step 1210, second network element may compress Q group(s) of reference data sample(s) according to Q first transformation matrix(es) respectively to obtain the Q group(s) of compressed reference data sample(s).

Each first transformation matrix in the Q first transformation matrix(es) corresponds to one of the Q group(s), respectively. Correspondingly, the Q first transformation matrix(es) may correspond to the Q layer(s), respectively.

The “first” in “first transformation matrix” is only used to illustrate that the transformation matrix can be used for compressing raw data and does not have any other limiting effect.

When Q is greater than 1, the Q first transformation matrices corresponding to different groups can be the same or different.

Optionally, a first transformation matrix be a unitary matrix or an orthonormal matrix. The first transformation matrix can be called basis or reference basis.

In some embodiments, each basis vector of the first transformation matrix may be a standard basis such as Fourier basis, DCT basis, wavelet basis, or the like.

In some embodiments, basis vectors of the first transformation matrix may be built as needed. As an example, basis vectors of the first transformation matrix may be built on the distribution of the corresponding group of the reference data samples.

A raw data sample represented by the first transformation matrix could be written as a finite weighted linear combination of elements of the first transformation matrix. The coefficients of this weighted linear combination are referred to as coordinates of the vector with respect to the first transformation matrix. For example, a compressed reference data sample can be represented by the coefficients with respect to the first transformation matrix.

In order to facilitate understanding of the embodiment of the present application, the following describes an example process of compression.

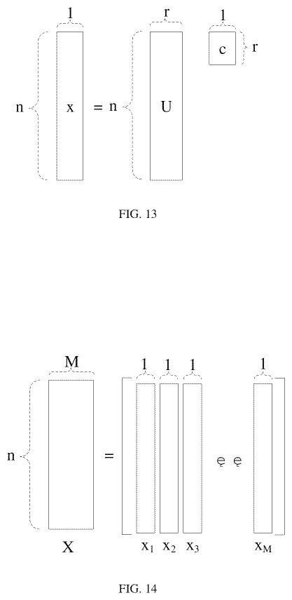

FIG. 13 is a schematic diagram of an example compression process of a reference data sample.

As shown in FIG. 13, one reference data sample x may be denoted as an n×1 reference sample, where n is an integer greater than 1. x is taken from the original high-dimensional space. The first transformation matrix U corresponding to the reference data sample x may be denoted as an n×r matrix, where r is a positive integer smaller than n. U may be a unitary or orthonormal matrix. For the convenience of description, the column is used as a basis vector in the embodiments of the present application. One column of U is one of the basis vectors, which means that any two columns of U are perfectly orthogonal to each other. As shown in FIG. 13, the matrix U consists of r basis vectors. It can be easily applied to that basis matrix whose rows are basis vectors; simply U^{H}.

x can be represented by a weighted linear combination of each column of U:x=Uc, where c is r×1 spectrum coefficients or weights. c is an equivalent low-dimensional space data (vector) of x, or in other words, c is the compressed reference data sample of x. Further, r<<n. Matrix U may be a unitary matrix, in which case U^{H}U=I and c=U^{H}x. The matrix U^{H} is the encoder or compressor that encodes a high-dimensional (n×1) reference data sample x into a low-dimensional (r×1) compressed reference data sample c. In other implementations, U^{H} can also be considered as the first transformation matrix. In order to facilitate understanding of the embodiment of the present application, U is taken as the first transformation matrix as an example.

In order to facilitate understanding of the embodiment of the present application, the following takes Q=2 as an example for explanation. Group #1 of reference data sample(s) may be denoted as X₁=[x_{1,1} x_{1,2} . . . x_{1,M}_{₁}], which may be encoded to a compressed version with the conjugate transpose of the first transformation matrix U₁·x_{1,1} is the first reference data sample in group #1 of reference data sample(s), x_{1,2} is the second reference data sample in group #1 of reference data sample(s), and so on. M₁ is the number of elements in group #1 of reference data sample(s). The number of reference data samples is the number of compressed reference samples. M₁ is a positive integer. The compressed version is the group #1 of compressed reference data sample(s), which can be denoted as [symbol] =[C_{1,1} C_{1,2} . . . C_{1,M}_{₁}]·X₁=U₁ [symbol] ·c_{1,1} is the first compressed reference data sample in group #1 of compressed reference data sample(s), c_{1,2} is the second reference data sample in group #1 of compressed reference data sample(s), and so on. The group #2 of reference data sample(s) may be denoted as X₂=[x_{2,1} x_{2,2} . . . x_{2,M}_{₂}], which may be encoded to a compressed version with the conjugate transpose of the first transformation matrix U₂·x_{2,1} is the first reference data sample in group #2 of reference data sample(s), x_{2,2} is the second reference data sample in group #2 of reference data sample(s), and so on. M₂ is the number of elements in group #2 of reference data sample(s). M₂ is a positive integer. The compressed version is the group #2 of compressed reference data sample(s), which can be denoted as [symbol] =[c_{2,1} C_{2,2} . . . C_{2,M}_{₂}]·X₂=U₂ [symbol] ·c_{2,1} is the first compressed reference data sample in group #2 of compressed reference data sample(s), c_{2,2} is the second reference data sample in group #2 of compressed reference data sample(s), and so on. U₁ and U₂ may be the same or different. In step 1220, the first network element receives [symbol] and [symbol] . Further, the first network element may also receive U₁ and U₂.

For example, each column of matrix U above may be a standard basis such as Fourier basis, DCT basis, wavelet basis, or the like.

For another example, the r columns of the matrix U above may be built on the distribution of the corresponding group of the reference data samples.

An example procedure to calculate the matrix U on the distribution of the corresponding group of the reference data samples may be as follows:

1) Accumulating a sufficient amount (M) n×1 reference data samples: x₁, x₂, . . . , x_{M}. The M reference data samples belong to the same group. M<<n. M is a positive integer.

FIG. 14 is a schematic diagram of an example X.

2) Juxtaposing the M reference data samples into a n×M matrix X=[x₁ x₂ . . . X_{M}]. The order of the reference data samples in the matrix X does not matter.

3) Applying a rank-reduced singular value decomposition (SVD) on X:X=U Σ_V^{H}, where U is n×r unitary or orthonormal matrix representing a commonality among all the M reference data samples, V^{H} is a unitary or orthogonal matrix. Σ is a diagonal matrix.

In some embodiments, the Q first transformation matrix(es) may be determined by the second network element.

When the second network element is a network device, the Q first transformation matrix(es) may be configured by the network device.

Optionally, method 1200 may also include: sending information #1 (an example of the first information) indicating the Q first transformation matrix(es) by the second network element to the first network element.

For example, the information #1 may include one or more first transformation matrices and the correspondence between the one or more first transformation matrices and the Q group(s) of the compressed reference data sample(s).

For another example, the information #1 may include one or more matrices related to the Q first transformation matrix(es) and the correspondence between the one or more matrices and the Q group(s) of the compressed reference data sample(s), so that the first network element can determine the Q first transformation matrix(es).

Exemplarily, the second network element may send Q conjugate transpose matrix(es) of the Q first transformation matrix(es).

For another example, the information #1 may include the index(es) of the Q first transformation matrix(es).

Exemplarily, there may be multiple first candidate transformation matrices in the first network element. As an example, there may be multiple candidate first transformation matrices with different sizes of space to achieve different resolutions. The multiple candidate first transformation matrices with different sizes of space may be multiple matrices with different numbers of columns. The information #1 may include the index of the Q first transformation matrix(es) within the multiple candidates.

The information #1 can also be in other forms, as long as it can indicate which group corresponds to which first transformation matrix.

In some embodiments, the Q first transformation matrix(es) may be determined by the first network element. The first network element may send information #2 indicating the Q first transformation matrix(es) to the second network element.

The form of information #2 may refer to the information #1, and will not be repeated here.

In some embodiments, the correspondence between the Q first transformation matrix(es) and the Q group(s) may be predefined.

The following describe the Q layer(s).

In some embodiments, the Q layer(s) may be determined by the second network element.

Optionally, method 1200 may also include: sending information #3 (an example of the third information) indicating the correspondence between the Q layer(s) and the Q group(s) by the second network element to the first network element.

For example, the information #3 may include the Q indicator(s) indicating the Q layer(s) respectively.

The information #3 can also be in other forms, as long as it can indicate which group corresponds to which layer.

In some embodiments, the Q layer(s) may be determined by the first network element. The first network element may send information #4 indicating the Q layer(s) to the second network element.

The form of information #4 may refer to the information #3, and will not be repeated here.

In some embodiments, the correspondence between Q layer(s) and Q group(s) may be predefined.

If the dimensions of the reference data sample are high, the first transformation matrix may also request high dimensions. In addition, if the first transformation matrix is an orthonormal matrix, it cannot be compressed. The first transformation matrix may require high bandwidth, and affect transmission efficiency.

For example, first transformation matrix U may be denoted as an n×r matrix. If n is a large number, sending the first transformation matrix may require a lot of resources, which can affect transmission efficiency.

### Example #2

Optionally, step 1210 may include: sampling Q group(s) of reference data sample(s), by the second network element, through Q sampling matrix(es) respectively to obtain the sampling result(s) of the Q group(s) of reference data sample(s); and compressing sampling result(s) of the Q group(s) of reference data sample(s), by the second network element, according to the Q second transformation matrix(es) respectively to obtain the Q group(s) of compressed reference data sample(s).

The sampling matrix may be used to sample values at some positions of an original data example.

For one reference data sample, the second network element may sample values at some positions of the reference data example through the sampling matrix. Then the second network element compresses the sampling result of the reference data sample according to the second transformation matrix.

Each sampling matrix in the Q sampling matrix(es) corresponds to one of the Q group(s), respectively. Correspondingly, the Q sampling matrix(es) may correspond to the Q layer(s), respectively.

Each second transformation matrix in the Q second transformation matrix(es) corresponds to one of the Q group(s), respectively. Correspondingly, the Q second transformation matrix(es) may correspond to the Q layer(s), respectively.

The “second” in “second transformation matrix” is only used to illustrate that the transformation matrix is related to the compression of the sampling result of the raw data and does not have any other limiting effect. The second transformation matrix can also be called a compact matrix.

When Q is greater than 1, the Q sampling matrices corresponding to different groups can be the same or different.

When Q is greater than 1, the Q second transformation matrices corresponding to different groups can be the same or different.

The following describes the relationship between the first transformation matrix, the sampling matrix and the second transformation matrix.

Optionally, the Q second transformation matrix(es) may be obtained by sampling the Q first transformation matrix(es) with the Q sampling matrix(es), respectively.

A first transformation matrix may be sampled to a compact matrix which is smaller than the first transformation matrix through a sampling matrix.

Optionally, a sampling matrix may be a random matrix or a pseudo-random matrix.

A first transformation matrix may be n×r matrix, and the corresponding sampling matrix may be denoted as m×n matrix. m is a positive integer smaller than n. Further, m<<n. For example, the sampling matrix P may be as follows:

$$P = [ \begin{matrix}0 & ... & 1 & ... & 0 & ... & 0 & ... & 0 \\ 0 & ... & 0 & ... & 1 & ... & 0 & ... & 0 \\ & & & & ... & & & & \\ 0 & ... & 0 & ... & 0 & ... & 1 & ... & 0\end{matrix} ] .$$

Only one position in each row of the sampling matrix has a value other than 0. For example, each row of the sampling matrix has only one “1”, and the remaining value(s) in each row are “0”. In this way, the position of the value other than 0 in each row of the sample matrix indicates the sampled position in the raw data sample. Correspondingly, the number of rows in the sampling matrix is the number of positions sampled in the raw data sample.

The above is merely an example of a sampling matrix. The sampling matrix can also be in other forms.

In order to facilitate understanding of the embodiment of the present application, the following describes a possible process of the compressing first transformation matrix.

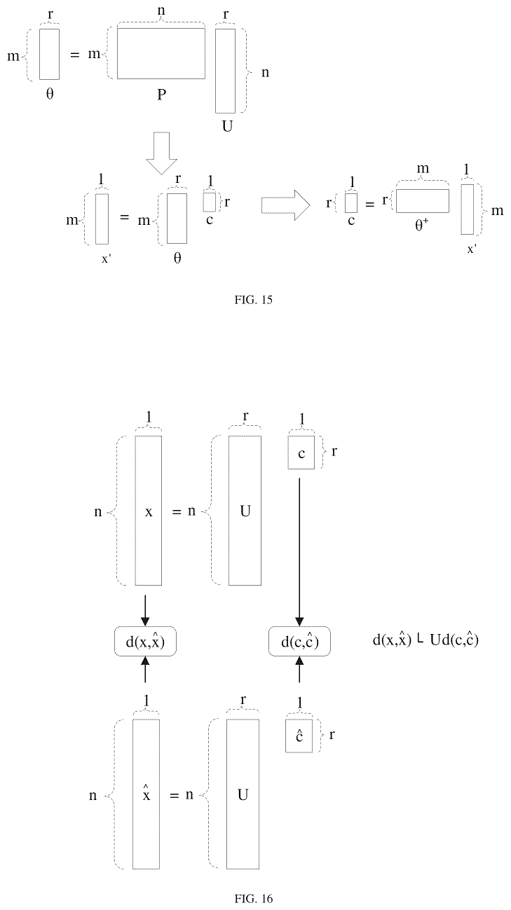

FIG. 15 is a schematic diagram of an example compression process of a first transformation matrix.

One reference data sample x may be denoted as an n×1 sample. A first transformation matrix U corresponding to x may be denoted as an n×r matrix. A sampling matrix P corresponding to x may be applied to U. P may be denoted as an m×n matrix, where m<n, and m is a positive integer. Further, m<<n. Each row of P has only one “1” to indicate the position of x to be sampled, and the remaining value(s) in each row are “0”. P may be used to “compress” U into a compact matrix θ, which is an m×r matrix. As shown in FIG. 15, θ=PU and x′=θc·x′ is an m×1 sample composed of the values sampled from x. According to the technical solution mentioned above, since m<n, θ is smaller than U. Therefore, θ can be a better alternative to U.

The following takes two groups mentioned above as an example for explanation. Group #1 of reference data sample(s) may be denoted as X₁=[x_{1,1} x_{1,2} . . . x_{1,M}_{₁}]. Group #2 of reference data sample(s) may be denoted as X₂=[x_{2,1} x_{2,2} x_{2,M}_{₂}]. The first transformation matrix U₁ and the first transformation matrix U₂ may be different. The sampling matrix P₁ corresponding to group #1 and the sampling matrix P₂ corresponding to group #2 may be different. U₁ is n₁×r₁·U₂ is n₂×r₂·n₁ and n₂ refer to n mentioned above. r₁ and r₂ refer to r mentioned above. If n₁ and/or n₂ are very big numbers, P₁ can be applied to the U₁, and/or P₂ can be applied to U₂·P₁ is m₁×n₁, each row of which has only one “1” to indicate the position of x_{1,i} to be sampled, and P₂ is m₂×n₂, each row of which has only one “1” to indicate the position of x_{2,i} to be sampled. P₁ can “compress” U₁ into a second transformation matrix θ₁ of m₁×r₁ as θ₁=P₁U₁. In case of m₁<<n₁,θ₁ is much smaller than U₁, and θ₁ can be a better alternative to U₁. P₂ can “compress” U₂ into a second transformation matrix θ₂ of m₂×r₂ as θ₂=P₂U₂. In case of m₂<<n₂, θ₂ is much smaller than U₂, and θ₂ can be a better alternative to U₂.

When the second network element compresses the Q group(s) of reference data sample(s) with the Q sampling matrix(es) and the Q second transformation matrix(es), the relevant compression method may refer to Example #4, where the local data sample may be replaced with reference data sample, and will not be repeated here.

The second network element may obtain the Q sampling matrix(es) and the Q second transformation matrix(es) in various ways.

In some embodiments, the Q sampling matrix(es) and the Q second transformation matrix(es) may be predefined.

In some embodiments, the Q sampling matrix(es) and the Q second transformation matrix(es) may be determined by the second network element.

For example, the second network element may calculate the Q second transformation matrix(es) through the Q sampling matrix(es) and the Q first transformation matrix(es). The Q first transformation matrix(es) and the Q sampling matrix(es) may be determined by the second network element. As an example, the Q first transformation matrix(es) and the Q sampling matrix(es) may be generated by the second network element.

In some embodiments, at least one of the Q sampling matrix(es), the Q second transformation matrix(es) or the Q first transformation matrix(es) may be configured by the other network element such as the first network element, while other items that are not configured by the other network element may be predefined or determined by the second network element itself.

Example #2-1: the second network element may receive the Q sampling matrix(es) and the Q second transformation matrix(es) from other network element.

Example #2-2: the second network element may receive the Q sampling matrix(es) and Q matrix(es) related to the Q second transformation matrix(es) from other network element, where the Q matrix(es) can be used to calculate the Q second transformation matrix(es). For example, the Q matrix(es) may be Q left inverse matrix(es) of the Q second transformation matrix(es).

Example #2-3: the second network element may receive the Q sampling matrix(es) and the Q first transformation matrix(es) from other network element. The Q second transformation matrix(es) can be calculated based on the Q sampling matrix(es) and the Q first transformation matrix(es).

Example #2-4: the second network element may receive the Q first transformation matrix(es) from the other network element. The Q sampling matrix(es) may be generated by the second network element. The Q second transformation matrix(es) can be calculated based on the Q sampling matrix(es) and the Q first transformation matrix(es).

Example #2-5: the second network element may receive the Q first transformation matrix(es) from the other network element. The Q sampling matrix(es) may be predefined. The Q second transformation matrix(es) can be calculated based on the Q sampling matrix(es) and the Q first transformation matrix(es).

In addition, the second network element can also determine the Q second transformation matrix(es) through other methods.

In example #2, the data sample can be obtained by compressing the raw data sample according to the sampling matrix and the transformation matrix. The dimensions of the sampling matrix and transformation matrix are smaller, which is beneficial to reducing the resources required for transmitting the sampling matrix and transformation matrix, thereby improving transmission efficiency.

Further, optionally, the method 1200 may also include step 1230.

Step 1230, the first network element measures the distance(s) between q group(s) of the first data sample(s) in the Q group(s) of the first data sample(s) and q group(s) of the second data sample(s), respectively. q is a positive integer less than or equal to Q.

The distance between the two in the embodiment of the present application can also be understood as the difference between the two. For example, the distance(s) between q group(s) of the first data sample(s) and q group(s) of the second data sample(s) can also be referred to as the difference(s) between q group(s) of the first data sample(s) and q group(s) of the second data sample(s).

The local data sample(s) generated by the second network element can be transmitted to first network element as reference data sample(s) for the AI model on the first network element.

For example, the second network element may transmit group #1 of its local data sample(s) and group #2 of its local data sample(s) to the first network element. The group #1 of the second network element's local data sample(s) can be regarded as the group #1 of the reference data sample(s) transmitted to the device #1. The group #2 of the second network element's local data sample(s) can be regarded as the group #2 of the reference data sample(s) transmitted to the device #1.

Exemplarily, step 1230 may be executed by the AI module of the first network element.

The q group(s) of the second data sample(s) corresponds to the q group(s) of the first data sample(s), respectively. The compression method of the q group(s) of the second data sample(s) is related to the compression method of the q group(s) of the first data sample(s).

In step 1230, one second data sample is obtained by compressing the corresponding second raw data sample. In other words, the dimension of the second data sample is smaller than the dimension of the corresponding second raw data sample.

The local data sample(s) mentioned above may be an example of second data sample(s). The compressed local data sample(s) mentioned above may be an example of second raw data sample(s). Method 1200 will be illustrated using this as an example.

Method 1200 may be applied to the inference cycle of AI model(s). Correspondingly, the second data sample(s) is related to the inference cycle of AI model(s).

Optionally, q group(s) of compressed local data sample(s) may correspond to q layer(s) of AI model(s), respectively.

In other words, q group(s) of local data sample(s) may correspond to q layer(s) of AI model(s), respectively.

Each group may correspond to one layer of AI model(s). Different groups may correspond to different layers.

As mentioned above, each group corresponds to output data or input data of one layer of AI model(s).

The q layer(s) may belong to one or more AI models. The method 1200 mainly takes q layer(s) belonging to one AI model as an example.

The specific description of the corresponding relationship can refer to the previous text, such as FIG. 9 or FIG. 10, and will not be repeated here.

The following describes two examples (example #3 and example #4) of compressing the local data sample.

### Example #3

Optionally, the first network element may compress q group(s) of local data sample(s) according to q first transformation matrix(es) respectively to obtain the q group(s) of compressed local data sample(s).

Each transformation matrix in the q first transformation matrix(es) corresponds to one of the q group(s), respectively. Correspondingly, the q first transformation matrix(es) may correspond to the q layer(s), respectively.

When q is greater than 1, the q first transformation matrices corresponding to different groups can be the same or different.

For example, the value of q may be determined by the first network element.

Alternatively, the value of q may be indicated by the second network element. Alternatively, the value of q may be predefined.

The following takes q=2 as an example for explanation. The group #1 of local data sample(s) may be denoted as \hat{X}₁=[\hat{x}_{1,1} \hat{x}_{1,2} . . . \hat{x}_{1,K}_{₁}]. \hat{x}_{1,1} is the first local data sample in the group #1 of local data sample(s), \hat{x}_{1,2} is the second local data sample in the group #1 of local data sample(s). The K₁ local data sample(s) may be obtained by randomly sampling K₁ data sample(s) on the corresponding layer #1. For example, the corresponding layer #1 may be the layer indicated by the indicator with the group #1 of compressed reference data sample(s). K₁ is positive integer. The K₁ data sample(s) may be the input(s) or output(s) of the corresponding layer #1. This is merely an example. The embodiments of the present application do not limit this. For example, the first network element may sample each data sample on the corresponding layer #1. Then the compressed local data sample ĉ_{1,i} may be calculated as

$${\hat{c}}_{1 , i} = {U}_{1}^{+} {\hat{x}}_{1 , i} \cdot {U}_{1}^{+}$$

is the reverse of U₁. The group #1 of compressed local data sample(s) is denoted as [symbol] =[ĉ_{1,1}, ĉ_{1,2} . . . ĉ_{1,K}_{₁}]. The group #2 of local data sample(s) may be denoted as \hat{X}₂=[\hat{x}_{2,1} \hat{x}_{2,2} . . . \hat{x}_{2,K}_{₂}]. \hat{X}_{2,1} is the first local data sample in the group #2 of local data sample(s), x_{2,2} is the second local data sample in the group #2 of local data sample(s). The K₂ local data sample(s) may be obtained by randomly sampling K₂ data sample(s) on the corresponding layer #2. K₂ is a positive integer. For example, the corresponding layer #2 may be the layer indicated by the indicator with the group #2 of compressed reference data sample(s). The K₂ data sample(s) may be the input(s) or output(s) of the corresponding layer #2. This is merely an example. The embodiments of the present application do not limit this. For example, the first network element may sample each data sample which may be the input(s) or output(s) of the corresponding layer. Then the compressed local data sample ĉ_{2,i} may be calculated as

$${\hat{c}}_{2 , i} = {U}_{2}^{+} {\hat{x}}_{2 , i \cdot } {U}_{2}^{+}$$

is the reverse of U₂. The group #2 of compressed local data sample(s) is denoted as [symbol] =[ĉ_{2,1} ĉ_{2,2} . . . C_{2,K}_{₂}].

The specific compression method may refer to Example #1, where the reference data sample may be replaced with a local data sample, and will not be repeated here.

The q first transformation matrix(es) may be related to the q group(s) of compressed reference data sample(s). For example, the q first transformation matrix(es) may also be used to compress the q group(s) of reference data sample(s), respectively.

The q first transformation matrix(es) belongs to the Q first transformation matrix(es). The determination method of the Q first transformation matrix(es) may refer to Example #1.

The q layer(s) belongs to the Q layer(s). The determination method of the Q layer(s) may refer to Example #1.

### Example #4

Optionally, the first network element may sample q group(s) of local data sample(s) through q sampling matrix(es) respectively to obtain the sampling result(s) of the q group(s) of local data sample(s); the first network element compresses sampling result(s) of the q group(s) of local data sample(s) according to q second transformation matrix(es) respectively to obtain the q group(s) of compressed local data sample(s).

For one local data sample, the first network element may sample values at some positions of the local data example through the sampling matrix. Then the first network element compresses the sampling result of the local data sample according to the second transformation matrix.

Each sampling matrix in the q sampling matrix(es) corresponds to one of the q group(s), respectively. Correspondingly, the q sampling matrix(es) may correspond to the q layer(s), respectively.

Each second transformation matrix in the q second transformation matrix(es) corresponds to one of the q groups, respectively. Correspondingly, the q second transformation matrix(es) may correspond to the q layer(s), respectively.

When q is greater than 1, the q sampling matrices corresponding to different groups can be the same or different.

When q is greater than 1, the q second transformation matrices corresponding to different groups can be the same or different.

The following takes q=2 as an example for explanation. The group #1 of local data sample(s) may be denoted as \hat{X}₁=[\hat{x}_{1,1} \hat{x}_{1,2} . . . \hat{x}_{1,K}_{₁}]. The relevant description of group #1 local data sample(s) can be referred to Example #3 and will not be repeated here. The first network element samples the group #1 of local data sample(s), where the first network element may sample the m₁ position(s) indicated by the sampling matrix #1 P₁ in the local data sample x_{1,i} into a m₁×1 local sample \hat{x}′_{1,i}·m₁ is a positive integer. m₁≤n₁·n₁ is the dimension of a local data sample in the group #1. Then the compressed local data sample ĉ_{1,i} may be calculated as

$${\hat{c}}_{1 , i} = {θ}_{1}^{+} {\hat{x}}_{1 , i} .$$

The group #1 of compressed local data sample(s) is denoted as [symbol] =[ĉ_{1,1} ĉ_{1,2} . . . ĉ_{1,K}_{₁}]. The group #2 of local data sample(s) may be denoted as \hat{X}₂=[\hat{x}_{2,1} \hat{x}_{2,2} . . . \hat{x}_{2,K}_{₂}]. The relevant description of group #2 of local data sample(s) can be referred to example #3 and will not be repeated here. The first network element samples the group #2 of local data sample(s), where the first network element may sample the m₂ position(s) indicated by the sampling matrix #2 P₂ in the local data sample \hat{x}_{2,i} into a m₂×1 local sample \hat{x}′_{2,i}·m₂ is a positive integer. m₂≤n₂·n₂ is the dimension of a local data sample in the group #2. Then the compressed local data sample ĉ_{2,i} may be calculated as

$${\hat{c}}_{2 , i} = {θ}_{2}^{+} {\hat{x}}_{2 , i}^{′} .$$

The group #2 of compressed local data sample(s) is denoted as [symbol] =[ĉ_{2,1} ĉ_{2, 2} . . . ĉ_{2,K}_{₂}].

The q sampling matrix(es) and the q second transformation matrix(es) may be related to the q group(s) of compressed reference data sample(s). For example, the q sampling matrix(es) and the q second transformation matrix(es) may also be used to compress the q group(s) of reference data sample(s), respectively. For another example, q first transformation matrix(es) may be used to compress the q group(s) of reference data sample(s), respectively, where the q first transformation matrix(es) may also be used to calculate the q second transformation matrix(es).

As mentioned above, the first network element may multiply the sampling result(s) of the q group(s) of local data sample(s) with the left inverse of the q second transformation matrix(es) to obtain the q group(s) of compressed local data sample(s).

The first network element may obtain the left inverse of the q second transformation matrix(es), such as

$${θ}_{1}^{+} and {θ}_{2}^{+}$$

mentioned above in various ways.

In some embodiments, the Q sampling matrix(es) and the Q second transformation matrix(es) may be predefined. The first network element calculates the left inverse of the Q second transformation matrix(es).

For example, the θ₁ and θ₂ may be predefined. And the first network element left inverses θ₁ into

$${θ}_{1}^{+}$$

and θ₂ into

$${θ}_{2}^{+} .$$

Alternatively, the Q sampling matrix(es) and the left inverse of Q second transformation matrix(es) may be predefined.

In some embodiments, the Q sampling matrix(es) and the Q second transformation matrix(es) may be determined by the first network element. The first network element calculates the left inverse of the Q second transformation matrix(es).

For example, the first network element may calculate the Q second transformation matrix(es) through the Q sampling matrix(es) and the Q first transformation matrix(es). The Q first transformation matrix(es) and the Q sampling matrix(es) may be determined by the first network element. For example, the Q first transformation matrix(es) and the Q sampling matrix(es) may be generated by the first network element.

And the first network element may indicate the Q sampling matrix(es) and the Q second transformation matrix(es) to the second network element. Relevant descriptions may refer to Example #2.

In some embodiments, at least one of the Q sampling matrix(es), the Q second transformation matrix(es) or the Q first transformation matrix(es) may be configured by the second network element, while other items that are not configured by the second network element may be predefined or determined by the first network element itself.

The first network element may receive information #5 (an example of the first information) indicating the left inverse of the Q second transformation matrix(es) from the second network element. The left inverse of the Q second transformation matrix(es) can be calculated through the Q second transformation matrix(es). Thus, the information #5 can also be understood as indicating Q second transformation matrix(es).

The following describes some example forms of information #5.

Example #4-1: the information #5 may include the Q sampling matrix(es) and the Q second transformation matrix(es). The first network element calculates the left inverse of the Q second transformation matrix(es).

For example, the first network element may receive P₁, θ₁, P₂ and θ₂ mentioned above from the second network element, then left inverse the θ₁ into θ₁⁺ and θ₂ into θ₂⁺.

Example #4-2: the information #5 may include Q sampling matrix(es) and Q matrix(es) related to the Q second transformation matrix(es), where the Q matrix(es) can be used to determine the left reverse of the Q second transformation matrix(es).

As an example, the information #5 may include Q sampling matrix(es) and the left reverse of the Q second transformation matrix(es).

For example, the first network element may receive P₁,

$${θ}_{1}^{+} ,$$

### P₂ and

$${θ}_{2}^{+}$$

mentioned above from the second network element.

Example #4-3: the information #5 may include Q sampling matrix(es) and Q first transformation matrix(es). The left inverse of the Q second transformation matrix(es) can be calculated based on the Q sampling matrix(es) and Q first transformation matrix(es).

For example, the first network element may receive P₁, U₁, P₂ and U₁ mentioned above from the second network element. Then first network element calculates

$${θ}_{1}^{+} as {θ}_{1}^{+} = {( {P}_{1} {U}_{1} )}^{+} and {θ}_{2}^{+} as {θ}_{2}^{+} = {( {P}_{2} {U}_{2} )}^{+} .$$

Example #4-4: the information #5 may include Q first transformation matrix(es). The left inverse of the Q second transformation matrix(es) can be calculated based on the Q sampling matrix(es) and Q first transformation matrix(es). The Q sampling matrix(es) may be generated by the first network element. Or the Q sampling matrix(es) may be predefined.

For example, the first network element may receive U₁ and U₁ mentioned above from the second network element. P₁ and P₂ may be generated locally by the first network element. Then first network element calculates

$${θ}_{1}^{+} as {θ}_{1}^{+} = {( {P}_{1} {U}_{1} )}^{+} and {θ}_{2}^{+} as {θ}_{2}^{+} = {( {P}_{2} {U}_{2} )}^{+} .$$

In addition, the first network element can also determine the left reverse of the Q second transformation matrix(es) through other methods. For example, the information #5 may include the index of the matrices mentioned above. Exemplarily, there may be multiple candidate sampling matrices and candidate second transformation matrices in the first network element. The information #5 may include the index of the Q sampling matrix(es) and the index of the Q second transformation matrix(es) within the multiple candidates.

In addition, the example #3 can also be executed through the Example #4. The first network element doesn't sample value(s) from the local data sample(s), mathematically the sampling matrix being an identity matrix. For example, P₁ is an identity matrix I and P₂ is an identity matrix I. The first network element calculates the left inverse of the second transformation matrix as

$${θ}_{1}^{+} = {( {P}_{1} {U}_{1} )}^{+} = {U}_{1}^{+} and {θ}_{2}^{+} = {( {P}_{2} {U}_{2} )}^{+} = {U}_{2}^{+} . If {U}_{1} is unitary , {θ}_{1}^{+} = {U}_{1}^{+} = {U}_{1}^{H} . If {U}_{2} is unitary , {θ}_{2}^{+} = {U}_{2}^{+} = {U}_{2}^{H} .$$

In example #4, the data sample can be obtained by compressing the raw data sample according to the sampling matrix and the second transformation matrix. The dimensions of the sampling matrix and the second transformation matrix are smaller, which is beneficial to reducing the resources required for transmitting the sampling matrix and second transformation matrix, thereby improving transmission efficiency. For example, the second network element may send Q sampling matrix(es) and Q second transformation matrix(es) to the first network element. Compared to sending Q first transformation matrix(es), this way may require fewer transmission resources due to the smaller dimensions of the second transformation matrix and sampling matrix compared to the first transformation matrix, which is beneficial to ensuring transmission efficiency.

The following describes the distance(s) between the q group(s) of first data sample(s) and the q group(s) of second data sample(s).

For a compressed local data sample and a compressed reference data sample corresponding to the same layer, the distance between the compressed local data sample and the compressed reference data sample is approximately the same as the distance between the raw local data sample and the raw reference data sample.

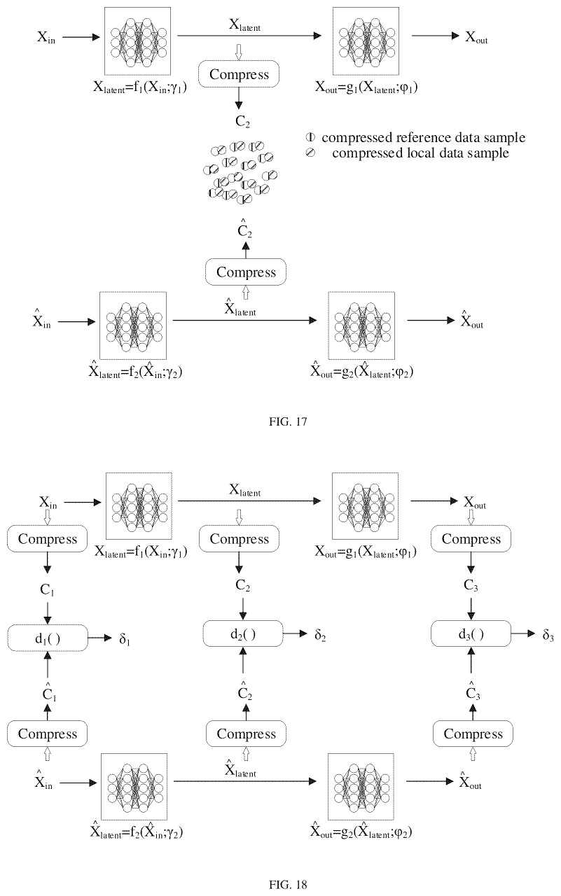

FIG. 16 is a schematic diagram of an example distance on the low spectrum space.

For example, as shown in FIG. 16, the distance between a local data sample 9 and a reference data sample x may be denoted as δ=d(x, \hat{x}), and the distance between the compressed local data sample c and the compressed reference data sample c may be denoted as δ=d(c, ĉ), where d( ) is the scoring function. d(x, \hat{x})≈Ud(c, ĉ).

Therefore, in some scenarios, the distance(s) between the q group(s) of compressed reference data sample(s) and the q group(s) of compressed local data sample(s) can be used to indicate the trend of the distance(s) between the q group(s) of reference data sample(s) and the q group(s) of local data sample(s). The q group(s) of the local data sample(s) may be the input(s) or output(s) of the corresponding layer(s). For example, each group of the local data sample(s) may be obtained by sampling the input(s) or output(s) of the corresponding layer. Further, each group of the local data sample(s) may be obtained by sampling the input(s) or output(s) of the corresponding layer.

The distance(s) between the q group(s) of the compressed reference data sample(s) and q group(s) of the compressed local data sample(s) may be calculated with q scoring function(s), respectively, where each scoring function of the q scoring function(s) may be used to measure the distance between the compressed local data sample from the group of compressed local data sample(s) corresponding to the scoring function and a compressed reference data sample from the group of compressed reference data sample(s) corresponding to the scoring function, or each scoring function of the q scoring function(s) may be used to measure the distance between the distribution of the group of compressed local data sample(s) corresponding to the scoring function and the distribution of the group of compressed reference data sample(s) corresponding to the scoring function.

The q scoring function(s) may correspond to the q group(s), respectively.

The following describes the q scoring functions.

The q scoring function(s) may correspond to the q layer(s), respectively.

When q>1, the q scoring function(s) may be the same or different.

The first network element may determine the q scoring function(s) in various ways.

Further, optionally, the method 1200 may also include: the first network element may receive information #6 (an example of the fourth information) indicating the Q scoring function(s) from the second network element. The Q scoring function(s) includes the q scoring function(s). The Q scoring function(s) may correspond to the Q layer(s), respectively.

For example, the information #6 may include the Q scoring function(s).

For another example, the information #6 may include the index of the Q scoring function(s).

Alternatively, the first network element may get the q scoring function(s) through other methods. For example, the q scoring function(s) corresponding to the q layer(s) may be predefined. For another example, the q scoring function(s) corresponding to the q layer(s) may be determined by the first network element.

In some embodiments, each scoring function may be used to measure the distance between two samples.

As an example, the scoring function may be one of dot product, inner product, Euclidean distance, and so on.

As another example, the scoring function may be DNN-based.

The following takes two groups mentioned above as examples for explanation. The group #1 of compressed reference data sample(s) may be denoted as [symbol] =[c_{1,1} c_{1,2} . . . c_{1,M}_{₁}]. The group #2 of compressed reference data sample(s) may be denoted as [symbol] =[c_{2,1} c_{2,2} . . . c_{2,M}_{₂}]. The group #1 of compressed local data sample(s) may be denoted as [symbol] =[ĉ_{1,1} ĉ_{1,2} . . . ĉ_{1,K}_{₁}], where K₁ is the number of the compressed local data samples in the group #1 of compressed local data sample(s) and K₁ is a positive integer. ĉ_{1,1} represents the first element in the group #1 of compressed local data sample(s), and ĉ_{1,2} represents the second element in the group #1 of compressed local data sample(s), and so on. The group #2 of compressed local data sample(s) may be denoted as [symbol] =[ĉ_{2,1} ĉ_{2,2} . . . ĉ_{2,K}_{₂}], where K₂ is the number of compressed local data samples in the group #2 of compressed local data sample(s) and K₂ is a positive integer. ĉ_{2,1} represents the first element in the group #2 of compressed local data sample(s), and ĉ_{2,2} represents the second element in the group #2 of compressed local data sample(s), and so on. There are two scoring functions, namely the scoring function #1 d₁( ) corresponding to the group #1 and the scoring function #2 corresponding to the group #2 d₂( ). The scoring function #1 d₁(c_{1,i}, ĉ_{1,i}) is used to measure the distance between two samples c_{1,i} and ĉ_{1,i}. The scoring function #2 d₂(c_{2,i}, ĉ_{2,i}) is used to measure the distance between two samples c_{2,i} and ĉ_{2,i}. The scoring function #1 d₁( ) and the scoring function #2 d₂( ) may be the same or different.

The distance between each two corresponding groups may be based on the distance between the data samples in the two groups.

As an example, the distance between each two corresponding groups may be the average minimum distance between the data samples in the two groups.

The following takes two groups mentioned above as examples for explanation.

For example, the scoring function #1 d₁( ) may be used to measure the distance between two samples for group #1. The distance δ₁ between the group #1 of compressed local data sample(s) and the group #1 of compressed reference data sample(s) may be the average minimum distance for the group #1, that is,

$${δ}_{1} = \frac{{\sum }_{k = 1}^{k = {K}_{1}} {min}_{j = 1 , 2 , … , {M}_{1}} ( {d}_{1} ( {\hat{c}}_{1 , k} , {c}_{1 , j} ) )}{{K}_{1}} .$$

The scoring function #2 d₂( ) may be used to measure the distance between two samples for group #2. The distance δ₁ between the group #2 of compressed local data sample(s) and the group #2 of compressed reference data sample(s) may be the average minimum distance for the group #2, that is

$${δ}_{2} = \frac{{\sum }_{k = 1}^{k = {K}_{2}} {min}_{j = 1 , 2 , … , {M}_{2}} ( {d}_{2} ( {\hat{c}}_{2 , k} , {c}_{2 , j} ) )}{{K}_{2}} .$$

In some embodiments, each scoring function may be used to measure the distance between two distributions.

As an example, the scoring function may be one of the following: mutual information, Hilbert-Schmidt independence criterion (HSIC) metric, Kullback-Leibler divergence (KL divergence), graph edit distance, Wasserstein distance, Jensen-Shannon distance (JSD distance), and so on.

As another example, the scoring function may be DNN-based.

The following takes two groups mentioned above as examples for explanation.

There are two scoring functions, namely the scoring function #1 d₁( ) corresponding to the group #1 and the scoring function #2 corresponding to the group #2 d₂( ). The scoring function #1 d₁( [symbol] , Ĉ₁) is used to measure the distance between two distributions [symbol] and Ĉ₁ of the group #1. The scoring function #2 d₂(C₂, [symbol] ) is used to measure the distance between two distributions C₂ and [symbol] of the group #2. The scoring function #1 d₁( ) and the scoring function #2 d₂( ) may be the same or different.

The distance between each two corresponding groups may be based on the distance between two distributions of the two groups.

The following takes two groups mentioned above as examples for explanation.

For example, the scoring function #1 d₁( ) may be used to measure the distance between two distributions for the group #1. The distance δ₁ between the group #1 of compressed local data sample(s) and the group #1 of compressed reference data sample(s) may be the distance between two distributions for the group #1, that is, δ₁=d₁(C₁, [symbol] ). The scoring function #2 d₂( ) may be used to measure the distance between two distributions for the group #2. The distance δ₂ between the group #2 of compressed local data sample(s) and the group #2 of compressed reference data sample(s) may be the distance between two distributions for the group #2, that is, θ₂=d₂(C₂, [symbol] ).

The measure methods of distance for different groups can be the same or different. For example, the distance δ₁ between the group #1 of compressed local data sample(s) and the group #1 of compressed reference data sample(s) may be the average minimum distance for the group #1, and the distance δ₂ between the group #2 of compressed local data sample(s) and the group #2 of compressed reference data sample(s) may be the distance between two distributions for the group #2.

Optionally, the first network element may calculate the higher order such as root mean square (RMS), standard deviation of δ₁ and δ₂.The higher order is conducive to more accurate determination of the difference between the group of the compressed local data samples and the group of the compressed reference samples.

For a first data sample and a second data sample corresponding to the same layer, the distance between the first data sample and the second data sample is approximately the same as the distance between the first raw data sample and the second raw data sample. In this way, computational complexity can be reduced, which is beneficial to improving processing efficiency.

The first network element may process and/or communicate based on the distance(s) between q group(s) of the first data sample(s) in the Q group(s) of the first data sample(s) and q group(s) of the second data sample(s).

Optionally, the first network element may send information #7 (an example of the second information) indicating the distance(s) between q group(s) of the first data sample(s) in the Q group(s) of the first data sample(s) and q group(s) of the second data sample(s).

Exemplarily, information #7 may be transmitted by the communication module of the first network element.

As an example, the information #7 may indicate the q distance(s) corresponding to the q group(s). For example, the information #7 may include the q distance(s).

As mentioned before, q is less than or equal to Q. When q is less than Q, the number of groups of compressed reference data samples received by the first network element is greater than the number of distances sent by the first network element.

The first network element may send the distance(s) in broadcast, multicast, or unicast way.

If the first network element sends distances of multiple groups, the sending way for distances of different groups can be the same or different.

As another example, there may be multiple distance ranges. Each distance range corresponds to a level. The information #7 may indicate q level(s) corresponding to the distance range(s) to which the q distance(s) belong.

As another example, the information #7 may indicate the statistical value of the q distances.

Exemplarily, the statistical value of the q distances may include the average, maximum, total, or minimum value of the q distances.

For example, the first network element may send the maximum distance of the q distances.

The following describes an example explanation of the timing of sending the information #7.

For example, the first network element may send the information #7 once the distance(s) have been measured.

For another example, the first network element may send the information #7 in response to the request sent by the other network element(s) for the measurement result.

For another example, the first network element may send the information #7 when the new measurement result is different from the older measurement result.

Group #1 is taken as an example. The first network element receives group #1 of compressed reference data sample(s) at time #1 and calculates the distance based on the current group #1 of compressed local data sample(s). The first network element receives group #1 of compressed reference data sample(s) at time #2 and calculates the distance based on the current group #1 of compressed local data sample(s). Time #2 and time #1 may belong to the same inference cycle of an AI model, and time #2 is later than time #1. The first network element may be moving, local data samples may change. Correspondingly, the distances corresponding to group #1 calculated at different times may also be different. The first network element may send the information #7 when the new measurement result corresponding to time #2 is different from the older measurement result corresponding to time #1.

In addition, the communication system of the device may receive the new groups of compressed reference data samples, new encoders, and/or new scoring functions from one period of time to another. The AI module of the device may use the most recent compressed reference data samples, encoders, and/or scoring functions to its local data samples and the communication system of the device may transmit the information indicating the most recent measurement results with the most recent compressed reference data samples, encoders, and/or scoring functions to its local data samples.

Optionally, the first network element may use the distance(s) between q group(s) of the first data sample(s) in the Q group(s) of the first data sample(s) and q group(s) of the second data sample(s) as judgment benchmark in some application scenarios.

The distance(s) can be used for performing checking.

Performing checking may include checking whether the current inference cycle is abnormal or not.

In the embodiment of the application, “checking whether the current inference cycle is abnormal or not” can also be replaced by the following description: checking whether the AI model can work as expected; checking whether the distance(s) meets the expectation; checking whether the distance(s) meets the conditions; checking whether the distance(s) is within the predefined range; checking whether the AI model meets expectation; checking whether the AI model is a candidate model matching another AI model, and so on.

For the convenience of description, the embodiment of the present application mainly takes checking whether the current inference cycle is abnormal or not.

In some application scenarios, the measure results may be used to detect whether the current inference cycle is abnormal or not. The detection method can refer to the previous text, replacing the distance(s) in the original dimensional space with the distance(s) in a lower dimensional space, and will not be repeated here.

Further, optionally, the detection results of the inference cycle may be indicated to another network element.

In addition, the above actions executed by the second network element can also be executed by the first network element. The above actions executed by the second network element can also be executed by a third network element. The third network element and second network element can be the same device or different devices. The first network element and second network element are different devices.

The following is an example of Q=2, which does not constitute a limitation on the technical solution of the present application. Other descriptions can refer to the previous text and will not be repeated here.

For example, the communication module of the first network element transmits U₁, group #1 of its compressed local data samples, U₂ and group #2 of its compressed local data samples to the third network element. The third network element receives group #1 of first network element's compressed local data samples as its group #1 of the reference data samples and group #2 of first network element's compressed local data samples as its group #2 of the reference data samples.

Alternatively, the communication module of the first network element transmits θ₁, P₁, group #1 of its compressed local data samples, θ₂, P₂, and group #2 of its compressed local data samples to the third network element. The third network element receives group #1 of first network element's compressed local data samples as its group #1 of the reference data samples and group #2 of first network element's compressed local data samples as its group #2 of the reference data samples.

Alternatively, the communication module of the first network element transmits

$${θ}_{1}^{+} ,$$

P₁, and group #1 of its compressed local data samples to the third network element. the communication module of the first network element transmits

$${θ}_{2}^{+} ,$$

P₂, and group #2 of its compressed local data samples to the third network element. The third network element receives group #1 of first network element's compressed local data samples as its group #1 of the reference data samples and group #2 of first network element's compressed local data samples as its group #2 of the reference data samples.

The communication module of the first network element may transmit the scoring function #1 d₁(c_{1,i}, ĉ_{1,i}) that measures the distance between two samples, c_{1,i} and ĉ_{1,i} of the group #1. The communication module of the first network element may transmit the scoring function #2 d₂(c_{2,i}, ĉ_{2,i}) that measures the distance between two samples, c_{2,i} and ĉ_{2,i} of the group #2. The scoring function #1 d₁( ) and the scoring function #2 d₂( ) may be the same or different.

The scoring function #1 d₁( ) and the scoring function #2 d₂( ) may be dot product, inner product, Euclidean distance, and so on. Alternatively, the scoring function #1 d₁( ) and the scoring function #2 d₂( ) may be DNN-based.

Alternatively, the communication module of the first network element may transmit the scoring function #1 d₁( [symbol] , [symbol] ) that measures the distance between two distributions, [symbol] and [symbol] , of the group #1. The communication module of the first network element may transmit the scoring function #2 d₂ ( [symbol] , [symbol] ) that measures the distance between two distributions, [symbol] and [symbol] , of the group #2. The scoring function #1 d₁( ) and the scoring function #2 d₂( ) may be the same or different.

The scoring function #1 d₁( ) and the scoring function #2 d₂( ) may be mutual information, HSIC metric, KL divergence, graph edit distance, Wasserstein distance, JSD distance, and so on. Alternatively, the scoring function #1 d₁( ) and the scoring function #2 d₂( ) may be DNN-based.

The following describes an exemplary explanation of method 1200 of the embodiments in the present application based on two examples (Example scenario-1 and Example scenario-2).

### Example Scenario-1

Optionally, method 1200 may be used to check AI model generalization. In other words, the method 1200 can be used to check whether the AI model can work.

For example, the AI module of the first network element may check if the distance(s) satisfies the conditions above. If the AI module of the first network element suspects the distance(s) do not meet the conditions above, it may decide that the AI model cannot work.

Further, optionally, the method 1200 may also include the following step.

The first network element may send information #7 indicating the distance(s) between q group(s) of the first data sample(s) and q group(s) of the second data sample(s).

If the first network element reports the distance(s) between q group(s) of the first data sample(s) and q group(s) of the second data sample(s) to the second network element, the second network element may determine whether the AI model can work.

Further, if the inference cycle of current AI model deployed on the first network element is abnormal, the current AI model may be replaced. For example, the current AI model may be switched to other AI models. Alternatively, the current AI model may be replaced by a non-AI model.

The switched model can be configured by the second network element.

Alternatively, the switched model can also be determined by the first network element and notified to the second network element.

### Example Scenario-2

In some scenarios, a plurality of AI models deployed on different devices may need to work together. These AI models may be trained independently by different providers.

Optionally, method 1200 may be used to check the interconnection of a plurality of AI models.

For example, the AI module of the first network element may check if the distance(s) satisfies the conditions above. If the AI module of the first network element suspects the distance(s) do not meet the conditions above, it may decide that the AI model cannot work with another AI model.

The first network element may send information #7 indicating the distance(s) between q group(s) of the first data sample(s) and q group(s) of the second data sample(s).

If the first network element reports the distance(s) between q group(s) of the first data sample(s) and q group(s) of the second data sample(s) to the second network element, it can also be performed by the second network element to determine whether the AI model can work with another AI model.

For example, an encoder and a decoder deployed on different devices may need to work together. The encoder can be deployed on the transmitter side and the decoder can be deployed on the receiver side. The transmitter side is an encoding device. The receiver side is a decoding device. The encoder of the encoding device may output to the decoder of the decoding device.

The method 1200 may be applied to check whether the encoder and the decoder deployed on different devices can work together.

The following takes a DNN-based autoencoder as an example. The encoder can be an encoding DNN and the decoder can be a decoding DNN.

There are two devices, i.e. device #1 and device #2. The AE #1 deployed on the device #1 and AE #2 deployed on the device #2 need to work together. For example, the device #1 may include the modules shown in FIG. 3, where the sensing module may be used to collect the local data, AI module may be used to perform inference on an its local data with encoding DNN #1 in the AE #1, and communication module may be used to receive signals and/or data and transmit signals and/or data. The device #2 may include the modules shown in FIG. 3, where the sensing module may be used to collect the local data, AI module may be used to perform inference on the data received from the encoding DNN on other device with decoding DNN #2 in the AE #2, and communication module may be used to receive signals and/or data and transmit signals and/or data.

The encoding DNN on the device #1 need to work with the decoding DNN on the device #2. The distance(s) can be used to determine whether the AI models on two devices can work together.

Exemplarily, the device #1 can be the first network element, and the device #2 can be the second network element. Alternatively, the device #1 can be the second network element, and the device #2 can be the first network element.

FIG. 17 is a schematic diagram of the autoencoder with one group of reference data samples.

For example, as shown in FIG. 17, the device #1 can be the first network element, and the device #2 can be the second network element.

The relationship between the input to the AE #2 Xᵢₙ and the latent layer output Xₗₐₜₑₙₜ can be represented as Xₗₐₜₑₙₜ=f₁(Xᵢₙ; γ₁)·f₁( ) represents the encoder #2 of the AE #2, and γ₁ represents parameters of the encoder #2 f₁( ). The relationship between the output of the AE #2 Xₒᵤₜ and the latent layer output can be represented as Xₒᵤₜ=g₁(Xₗₐₜₑₙₜ; φ₁)·g₁( ) represents the decoder #2 of the AE #2, and φ₁ represents parameters of the decoder #2 g₁( ). Xₗₐₜₑₙₜ is the output of the encoder #2, and also the input of the decoder #2.

The relationship between the input to the AE #1 \hat{X}ᵢₙ and the latent layer output \hat{X}ₗₐₜₑₙₜ of the AE #1 can be represented as \hat{X}ₗₐₜₑₙₜ=f₂(\hat{X}ᵢₙ; γ₂)·f₂( ) represents the encoder #1 of the AE #1, and γ₂ represents parameters of the encoder #1 f₂( ). The relationship between the output of the AE #1 \hat{X}ₒᵤₜ and the latent layer output \hat{X}ₗₐₜₑₙₜ of the AE #1 can be represented as \hat{X}ₒᵤₜ=g₂(\hat{X}ₗₐₜₑₙₜ; φ₂)·g₂( ) represents the decoder #1 of the AE #1, and φ₂ represents parameters of the decoder #1 g₂( )·\hat{X}ₗₐₜₑₙₜ is the output of the encoder #1, and also the input of the decoder #1.

Method 1200 can be used to check whether AE #1 and AE #2 can work together. For example, method 1200 can be used to check whether the encoder #1 can work with decoder #2.

The AI module of the device #2 may compress the reference data samples to obtain the compressed reference data samples. The reference data samples may be sampled from Xₗₐₜₑₙₜ.

The communication module of the device #2 send the compressed reference data samples C to the device #1.

Further, the AI module of the device #2 may also generate second transformation matrix θ and sampling matrix P. The communication module of the device #2 may transmit [symbol] [symbol] , θ, P,d( ) [symbol] to the device #1. d( ) is the scoring function used to measure the distance(s) between the compressed local data samples and the compressed reference data samples.

The AI module of the device #1 may compress the local data samples to obtain the compressed local data samples according to the second transformation matrix θ and sampling matrix P. The local data samples may be sampled from \hat{X}ₗₐₜₑₙₜ.

The AI module of the device #1 measures the distance(s) between the reference data samples C received by the communication module of the device #1 and the local data samples [symbol] through the scoring function d( ).

The device #1 may check whether the encoder #1 can work with decoder #2 according to the distance(s).

Further, the communication module of the device #1 may transmit the check result to the device #2.

Alternatively, the device #1 may send the distance(s) to the device #2. The device #2 may receive the distance(s) and check whether the encoder #1 can work with decoder #2.

Further, the communication module of the device #2 may transmit the check result to the device #1.

The above is only an example. For example, in other implementations, device #2 can also serve as the first network element and device #1 can also serve as the second network element. For another example, in FIG. 17, one group of reference samples is sent, and in other implementations, a plurality of groups of reference samples can be sent.

FIG. 18 is a schematic diagram of three groups of reference data samples.

For example, as shown in FIG. 18, the device #1 can be the first network element, and the device #2 can be the second network element. The relevant descriptions of the two AEs can refer to the description in FIG. 17, and will not be repeated here.

The device #2 may generate three groups of compressed reference data samples, where the group #1 of compressed reference data samples (. [symbol] ) corresponds to the input (Xᵢₙ) to the AE #1, the group #2 of compressed reference data samples ( [symbol] ) corresponds to one latent layer output (Xₗₐₜₑₙₜ) of the AE #1, and the group #3 of compressed reference data samples ( [symbol] ) corresponds to the output (Xₒᵤₜ) from the AE #1. Further, the AI module of the device #2 may also generate second transformation matrix #1 θ₁ and sampling matrix #1 P₁ for the group #1, second transformation matrix #2 θ₂ and sampling matrix #2 P₂ for the group #2, and second transformation matrix #3 θ₃ and sampling matrix #3 P₃ for the group #3. The communication module of the device #2 may transmit [symbol] [symbol] , θ₁, P₁, d₁( ) [symbol] for the group #1, [symbol] [symbol] , θ₂, P₂, d₂ ( ) [symbol] for the group #2, [symbol] [symbol] , θ₃, P₃, d₃( ) [symbol] for the group #3, with the averaged neurons to the device #1 in unicast way. d₁( ) is the scoring function for group #1, d₂( ) is the scoring function for group #2, and d₃( ) is the scoring function for group #3. The AI module of the device #1 samples and compresses the local data samples (e.g., \hat{X}ᵢₙ, \hat{X}ₗₐₜₑₙₜ and \hat{X}ₒᵤₜ) to obtain the three groups of the compressed local data samples [symbol] , [symbol] , and [symbol] . The AI module of the device #1 measures the distances δ₁ for the group #1, δ₂ for the group #2, and δ₃ for the group #3. After the measurement is completed, the communication module of the device #1 may transmit the distances to the device #2. Further, the communication module of the device #1 may also transmit all of the neurons or a portion of its neurons to the device #2.

The transmission process in example scenario-1 and example scenario-2 are merely examples. For other implementation methods, please refer to method 1200. For example, in FIG. 18, the communication module of the first network element may transmit a portion of three distances. For another example, the scoring function(s) may be pre-defined.

The communication method according to the embodiments of the present application is described in detail above, and the communication apparatus according to the embodiments of the present application will be described in detail below with reference to FIGS. 19-23.

FIG. 19 is a schematic block diagram of a communication apparatus 10 according to an embodiment of the present application. As shown in FIG. 19, the communication apparatus 10 includes:

a processing module 11, configured to obtain Q group(s) of first data sample(s) corresponding to Q layer(s) of an AI model, where the Q group(s) of the first data sample(s) is from compressed Q group(s) of first raw data sample(s) which is compressed according to Q transformation matrix(es), the Q group(s) of the first data sample(s) is related to an inference cycle of the AI model, and Q is a positive integer; and

a transceiver module 12, configured to send the Q group(s) of the first data sample(s).

The communication apparatus 10 in this embodiment of the present application may correspond to the second network element in the communication method in the embodiments of the present application described above, and the foregoing management operations and/or functions and other management operations and/or functions of modules of the communication apparatus 10 are intended to implement corresponding steps of the foregoing methods. For brevity, details are not described herein again.

The transceiver module 12 in this embodiment of the present application may be implemented by a transceiver, and the processing module 11 may be implemented by a processor.

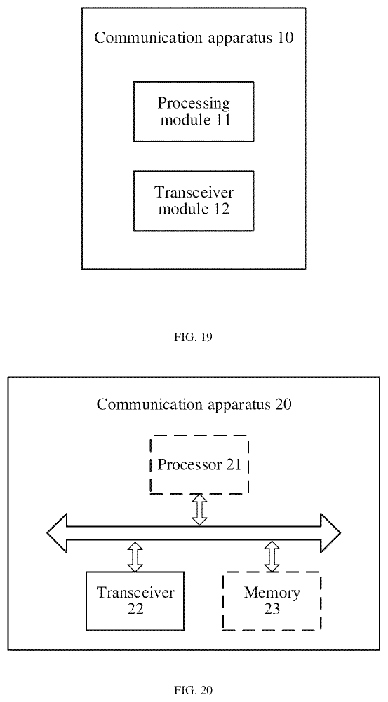

As shown in FIG. 20, a communication apparatus 20 may include a transceiver 21. Optionally, the communication apparatus 20 may further include a processor 22 and/or a memory 23. The memory 23 may be configured to store indication information, or may be configured to store code, instructions, and the like that is to be executed by the processor 22.

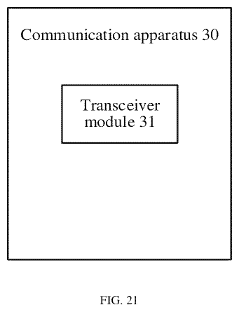

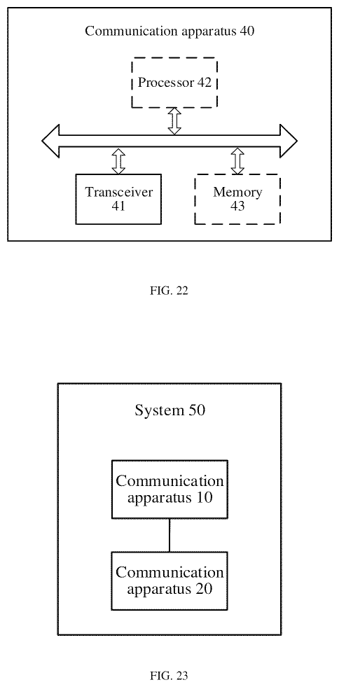

FIG. 21 is a schematic block diagram of a communication apparatus 30 according to an embodiment of the present application. As shown in FIG. 21, the communication apparatus 30 includes:

a transceiver module 31, configured to receive Q group(s) of first data sample(s) corresponding to Q layer(s) of an AI model, where the Q group(s) of the first data sample(s) is from compressed Q group(s) of first raw data sample(s) which is compressed according to Q transformation matrix(es), the Q group(s) of the first data sample(s) is related to an inference cycle of the AI model, and Q is a positive integer.

The communication apparatus 30 in this embodiment of the present application may correspond to the first network element in the communication method in the embodiments of the present application described above, and the management operations and/or functions and other management operations and/or functions of modules of the communication apparatus 30 are intended to implement corresponding steps of the foregoing methods. For brevity, details are not described herein again.

The transceiver module 31 in this embodiment of the present application may be implemented by a transceiver.

As shown in FIG. 22, a communication apparatus 40 may include a transceiver 41. Optionally, the communication apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processor 22 or the processor 42 may be a general-purpose processor, a digital signal processor (DSP), an application-specific integrated circuit (ASIC), a field programmable gate array (FPGA), or another programmable logic device, a discrete gate or a transistor logic device, or a discrete hardware component. All methods, steps, and logical block diagrams disclosed in this embodiment of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

It may be understood that the memory 23 or the memory 43 in the embodiments of the present invention may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory EEPROM), or a flash memory. The volatile memory may be a random access memory (RAM), and be used as an external cache. Through example but not limitative description, many forms of RAMs may be used, for example, a static random access memory (SRAM), a dynamic random access memory (DRAM), a synchronous dynamic random access memory SDRAM), a double data rate synchronous dynamic random access memory (DDR SDRAM), an enhanced synchronous dynamic random access memory (Enhanced SDRAM, ESDRAM), a synchronous link dynamic random access memory (SLDRAM), and a direct rambus dynamic random access memory (DR RAM). The storage of the system and the method described in this specification aim to include, but are not limited to, these and any other proper storage.

An embodiment of the present application further provides a system. As shown in FIG. 23, a system 50 includes:

the communication apparatus 10 according to the embodiments of the present application and the communication apparatus 20 according to the embodiments of the present application.

An embodiment of the present application further provides a computer storage medium, and the computer storage medium may store one or more program instructions for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of the present application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in the present application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of the present application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of the present application may be implemented in the form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a USB flash drive, a removable hard disk, a read-only memory (ROM), a random access memory (RAM), a magnetic disk, an optical disc or the like.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A communication method, comprising:
obtaining Q group(s) of first data sample(s) corresponding to Q layer(s) of an artificial intelligence (AI) model, wherein the Q group(s) of the first data sample(s) is from compressed Q group(s) of first raw data sample(s) compressed according to Q transformation matrix(es), the Q group(s) of the first data sample(s) is related to an inference cycle of the AI model, and Q is a positive integer; and
sending the Q group(s) of the first data sample(s).

2. The communication method according to claim 1, further comprising:
sending first information indicating the Q transformation matrix(es).

3. The communication method according to claim 2, wherein the first information further indicates Q sampling matrix(es), the Q sampling matrix(es) is used to sample Q group(s) of second raw data sample(s), and the Q transformation matrix(es) is used to compress sampling result(s) of the Q group(s) of the second raw data sample(s) into Q group(s) of second data sample(s).

4. The communication method according to claim 1, further comprising:
receiving second information indicating difference(s) between q group(s) of second data sample(s) and q group(s) of the first data sample(s) in the Q group(s) of the first data sample(s), wherein the q group(s) of the second data sample(s) is based on inputs or outputs of q layer(s) in the Q layer(s) during the inference cycle, q is a positive integer, and q≤Q.

5. The communication method according to claim 4, wherein the difference(s) between the q group(s) of the second data sample(s) and the q group(s) of the first data sample(s) is used to check whether the inference cycle is abnormal.

6. The communication method according to claim 1, further comprising:
sending third information indicating correspondence between the Q layer(s) and the Q group(s) of the first data sample(s).

7. An apparatus, comprising:
at least one processor coupled with a memory storing instructions that, when executed by the at least one processor, cause the apparatus to perform operations, wherein the operations comprise:
obtaining Q group(s) of first data sample(s) corresponding to Q layer(s) of an artificial intelligence (AI) model, wherein the Q group(s) of the first data sample(s) is from compressed Q group(s) of first raw data sample(s) compressed according to Q transformation matrix(es), the Q group(s) of the first data sample(s) is related to an inference cycle of the AI model, and Q is a positive integer; and
sending the Q group(s) of the first data sample(s).

8. The apparatus according to claim 7, the operations further comprising:
sending first information indicating the Q transformation matrix(es).

9. The apparatus according to claim 8, wherein the first information further indicates Q sampling matrix(es), the Q sampling matrix(es) is used to sample Q group(s) of second raw data sample(s), and the Q transformation matrix(es) is used to compress sampling result(s) of the Q group(s) of the second raw data sample(s) into Q group(s) of second data sample(s).

10. The apparatus according to claim 7, the operations further comprising:
receiving second information indicating difference(s) between q group(s) of second data sample(s) and q group(s) of the first data sample(s) in the Q group(s) of the first data sample(s), wherein the q group(s) of the second data sample(s) is based on inputs or outputs of q layer(s) in the Q layer(s) during the inference cycle, q is a positive integer, and q≤Q.

11. The apparatus according to claim 10, wherein the difference(s) between the q group(s) of the second data sample(s) and the q group(s) of the first data sample(s) is used to check whether the inference cycle is abnormal.

12. The apparatus according to claim 7, the operations further comprising:
sending third information indicating correspondence between the Q layer(s) and the Q group(s) of the first data sample(s).

13. The apparatus according to claim 7, the operations further comprising:
sending fourth information indicating Q scoring function(s), wherein the Q scoring function(s) is used to measure difference(s) between the Q group(s) of the first data sample(s) and Q group(s) of second data sample(s), and the Q group(s) of the second data sample(s) is based on inputs or outputs of the Q layer(s).

14. An apparatus, comprising:
at least one processor coupled with a memory storing instructions that, when executed by the at least one processor, cause the apparatus to perform operations, wherein the operations comprise:
receiving Q group(s) of first data sample(s) corresponding to Q layer(s) of an artificial intelligence (AI) model, wherein the Q group(s) of the first data sample(s) is from compressed Q group(s) of first raw data sample(s) compressed according to Q transformation matrix(es), the Q group(s) of the first data sample(s) is related to an inference cycle of the AI model, and Q is a positive integer.

15. The apparatus according to claim 14, the operations further comprising:
receiving first information indicating the Q transformation matrix(es).

16. The apparatus according to claim 15, wherein the first information further indicates Q sampling matrix(es), the Q sampling matrix(es) is used to sample Q group(s) of second raw data sample(s), and the Q transformation matrix(es) is used to compress sampling result(s) of the Q group(s) of the second raw data sample(s) into Q group(s) of second data sample(s).

17. The apparatus according to claim 14, the operations further comprising:
sending second information indicating difference(s) between q group(s) of second data sample(s) and q group(s) of the first data sample(s) in the Q group(s) of the first data sample(s), wherein the q group(s) of the second data sample(s) is based on inputs or outputs of q layer(s) in the Q layer(s) during the inference cycle, q is a positive integer, and q≤Q.

18. The apparatus according to claim 17, wherein the difference(s) between the q group(s) of the second data sample(s) and the q group(s) of the first data sample(s) is used to determine whether the inference cycle of the AI model is abnormal.

19. The apparatus according to claim 14, the operations further comprising:
receiving third information indicating correspondence between the Q layer(s) and the Q group(s) of the first data sample(s).

20. The apparatus according to claim 14, the operations further comprising:
receiving fourth information indicating Q scoring function(s), wherein the Q scoring function(s) is used to measure difference(s) between the Q group(s) of the first data sample(s) and Q group(s) of second data sample(s), and the Q group(s) of the second data sample(s) is based on inputs or outputs of the Q layer(s).
